(19) United States
(12) Patent Application Publication
(10) Pub. No.: US 2026/0304334 A1
(43) Pub. Date: Oct. 1, 2026

(54) DOWNLINK REFERENCE TIMING DETERMINATION FOR PHYSICAL RANDOM ACCESS CHANNEL IN MULTIPLE TRANSMISSION RECEPTION POINT COMMUNICATIONS

(71) Applicant: QUALCOMM INCORPORATED, San Diego, CA (US)

(72) Inventors: Shaozhen GUO, Beijing (CN); Mostafa KHOSHNEVISAN, San Diego, CA (US); Peter GAAL, San Diego, CA (US)

(21) Appl. No.: 19/102,368

(22) PCT Filed: Sep. 30, 2022
(86) PCT No.: PCT/CN2022/123122

§ 371 Date: Feb. 7, 2025

(51) Int. Cl. H04W 56/00; H04W 74/00; H04W 74/0833

(52) U.S. Cl. CPC H04W 56/0045; H04W 74/004; H04W 74/0833

(57) ABSTRACT

Methods, systems, and devices for downlink reference timing determination for physical random access channel in multiple transmission reception point communications are described. A user equipment (UE) may receive control signaling indicating two control resource set pool index values in an active bandwidth part of at least one serving cell. Two timing advance groups may be each associated with a timing advance offset for the serving cell. The UE may determine two downlink reference timings as the reference timing for uplink transmission. Each downlink reference timing may be associated with a timing advance group identity. The UE may then determine the uplink timing for a physical random access channel or physical uplink shared channel of a message. A based on one or both of the two timing advance offsets, and one or both of the two downlink reference timings, then transmit a preamble in accordance with the determined uplink timing.

### CROSS REFERENCE

This application is a 371 National Stage of PCT Application No. PCT/CN2022/123122, filed on Sep. 30, 2022, entitled “DOWNLINK REFERENCE TIMING DETERMINATION FOR PHYSICAL RANDOM ACCESS CHANNEL IN MULTIPLE TRANSMISSION RECEPTION POINT COMMUNICATIONS”, and assigned to the assignee hereof. The disclosure of the prior Application is considered part of and is incorporated by reference into this Patent Application.

### FIELD OF TECHNOLOGY

The following relates to downlink reference timing determination for physical random access channel in multiple transmission reception point communications, including downlink reference timing determination for physical random access channel in multiple transmission reception point communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support downlink reference timing determination for physical random access channel in multiple transmission reception point communications. For example, the described techniques provide for a user equipment (UE) to receive control signaling indicating two control resource set pool index values in an active bandwidth part of at least one serving cell. The two timing advance groups may be each associated with a timing advance offset and configured for the serving cell. The UE may determine two downlink reference timings as the reference timing for uplink transmission. Each downlink reference timing may be associated with a timing advance group identity. The UE may then determine the uplink timing for a physical random access channel (PRACH), or a physical uplink shared channel (PUSCH) of a message A, based at least in part on one or both of the two timing advance offsets, and one or both of the two downlink reference timings. The UE may transmit a preamble in a valid PRACH occasion, or a message A in a valid PUSCH occasion, of a random access procedure in accordance with the determined uplink timing.

A method for wireless communication at a user equipment (UE) is described. The method may include determining two downlink reference timings for an uplink transmission within a serving cell, where two timing advance groups each associated with a respective timing advance offset are configured for the serving cell, and where each of the two downlink reference timings is associated with a respective timing advance group of the two timing advance groups, determining an uplink timing for a random access preamble of a physical random access channel (PRACH) or a message A of a physical uplink shared channel (PUSCH) based on at least one of the two timing advance offsets, at least one of the two downlink reference timings, or any combination thereof, and transmitting, as part of a random access procedure, the random access preamble in a valid PRACH occasion or the message A in a valid PUSCH occasion in accordance with the determined uplink timing.

An apparatus for wireless communication at a UE is described. The apparatus may include memory, a transceiver, and at least one processor coupled with the memory and the transceiver and configured to determine two downlink reference timings for an uplink transmission within a serving cell, where two timing advance groups each associated with a respective timing advance offset are configured for the serving cell, and where each of the two downlink reference timings is associated with a respective timing advance group of the two timing advance groups, determine an uplink timing for a random access preamble of a physical random access channel (PRACH) or a message A of an PUSCH based on at least one of the two timing advance offsets, at least one of the two downlink reference timings, or any combination thereof, and transmit, as part of a random access procedure, the random access preamble in a valid PRACH occasion or the message A in a valid PUSCH occasion in accordance with the determined uplink timing.

Another apparatus for wireless communication at a UE is described. The apparatus may include means for determining two downlink reference timings for an uplink transmission within a serving cell, where two timing advance groups each associated with a respective timing advance offset are configured for the serving cell, and where each of the two downlink reference timings is associated with a respective timing advance group of the two timing advance groups, means for determining an uplink timing for a random access preamble of a physical random access channel (PRACH) or a message A of an PUSCH based on at least one of the two timing advance offsets, at least one of the two downlink reference timings, or any combination thereof, and means for transmitting, as part of a random access procedure, the random access preamble in a valid PRACH occasion or the message A in a valid PUSCH occasion in accordance with the determined uplink timing.

A non-transitory computer-readable medium storing code for wireless communication at a UE is described. The code may include instructions executable by a processor to determine two downlink reference timings for an uplink transmission within a serving cell, where two timing advance groups each associated with a respective timing advance offset are configured for the serving cell, and where each of the two downlink reference timings is associated with a respective timing advance group of the two timing advance groups, determine an uplink timing for a random access preamble of a physical random access channel (PRACH) or a message A of an PUSCH based on at least one of the two timing advance offsets, at least one of the two downlink reference timings, or any combination thereof, and transmit, as part of a random access procedure, the random access preamble in a valid PRACH occasion or the message A in a valid PUSCH occasion in accordance with the determined uplink timing.

In some examples of the method, apparatuses, and non-transitory computer-readable medium described herein, determining the uplink timing may include operations, features, means, or instructions for determining a single uplink timing for the random access preamble or the message A based on a single downlink reference timing of the two downlink reference timings and a single timing advance offset of the two timing advance offsets.

Some examples of the method, apparatuses, and non-transitory computer-readable medium described herein may further include operations, features, means, or instructions for identifying the single timing advance offset based on the single downlink reference timing and selecting the single downlink reference timing from among the two downlink reference timings based on the single downlink reference timing being an earliest in time among of the two downlink reference timings.

Some examples of the method, apparatuses, and non-transitory computer-readable medium described herein may further include operations, features, means, or instructions for identifying the single timing advance offset based on the single downlink reference timing and selecting the single downlink reference timing from among the two downlink reference timings based on the single downlink reference timing corresponding to a selected one of two control resource set pool index values for an active bandwidth part of the serving cell.

Some examples of the method, apparatuses, and non-transitory computer-readable medium described herein may further include operations, features, means, or instructions for selecting the single downlink reference timing from among the two downlink reference timings and the single timing advance offset from among the two timing advance offsets based on an uplink timing associated with the single downlink reference timing and the single timing advance offset being earlier than another uplink timing associated with the other downlink reference timing of the two downlink reference timings and the other timing advance offset of the two timing advance offsets.

Some examples of the method, apparatuses, and non-transitory computer-readable medium described herein may further include operations, features, means, or instructions for determining a time gap in symbols between an uplink resource and the valid PRACH occasion or the valid PUSCH occasion based on the uplink resource being associated with a different downlink reference timing than the single downlink reference timing, a different timing advance offset than the single timing advance offset, or both.

In some examples of the method, apparatuses, and non-transitory computer-readable medium described herein, refraining, based on the uplink resource being associated with the different downlink reference timing or the different timing advance offset, from transmitting using the uplink resource in a same slot as a PRACH occasion or a PUSCH occasion, or when a gap between a symbol of the PRACH occasion or the PUSCH occasion and a symbol of the uplink resource may be less than the determined time gap.

In some examples of the method, apparatuses, and non-transitory computer-readable medium described herein, refraining, based on identifying that simultaneous transmission using a PRACH occasion or a PUSCH occasion and the uplink resource allocated to the UE may be unsupported, from transmitting using the uplink resource in a same slot as the PRACH occasion or the PUSCH occasion, or when a gap between a symbol of the PRACH occasion or the PUSCH occasion and a symbol of the uplink resource may be less than the determined time gap.

Some examples of the method, apparatuses, and non-transitory computer-readable medium described herein may further include operations, features, means, or instructions for determining a time gap in symbols between a synchronization signal block occasion and the valid PRACH occasion or the valid PUSCH occasion based on the synchronization signal block occasion being associated with a first control resource set pool index value and the valid PRACH occasion or the valid PUSCH occasion being associated with a second control resource set pool index value different from the first control resource set pool index value.

Some examples of the method, apparatuses, and non-transitory computer-readable medium described herein may further include operations, features, means, or instructions for determining that a first PRACH occasion may be the valid PRACH occasion or a first PUSCH occasion may be the valid PUSCH occasion based on the first PRACH occasion or the first PUSCH occasion being at or after a synchronization signal block occasion and at least a threshold quantity of symbols after a previously received synchronization signal block.

Some examples of the method, apparatuses, and non-transitory computer-readable medium described herein may further include operations, features, means, or instructions for determining the threshold quantity of symbols based on whether the valid PRACH occasion or the valid PUSCH occasion and the synchronization signal block occasion may be both associated with a same control resource set pool index value.

In some examples of the method, apparatuses, and non-transitory computer-readable medium described herein, determining the uplink timing may include operations, features, means, or instructions for determining a downlink reference timing of the two downlink reference timings based on a control resource set pool index value that may be associated with the downlink reference timing being associated with a same control resource set pool index value associated with the valid PRACH occasion or the valid PUSCH occasion or a timing advance group of the two timing advance groups corresponding to the downlink reference timing and being associated with the same control resource set pool index value as the valid PRACH occasion or the valid PUSCH occasion, where the uplink timing may be determined based on the determined downlink reference timing.

In some examples of the method, apparatuses, and non-transitory computer-readable medium described herein, refraining, based on a PRACH occasion or a PUSCH occasion and an uplink resource both being associated with a same control resource set pool index value, from transmitting using the uplink resource in a same slot as the PRACH occasion or the PUSCH occasion, or when a gap between a symbol of the PRACH occasion or the PUSCH occasion and a symbol of the uplink resource may be less than a time gap that is based at least in part on the PRACH occasion or the PUSCH occasion and the uplink resource both being associated with the same control resource set pool index value.

In some examples of the method, apparatuses, and non-transitory computer-readable medium described herein, refraining, based on a PRACH occasion or a PUSCH occasion and an uplink resource both being associated with a different control resource set pool index value, from transmitting using the uplink resource in a same slot as the PRACH occasion or the PUSCH occasion, or when a gap between a symbol of the PRACH occasion or the PUSCH occasion and a symbol of the uplink resource may be less than a time gap that is based at least in part on the PRACH occasion or the PUSCH occasion and the uplink resource both being associated with a different control resource set pool index value.

Some examples of the method, apparatuses, and non-transitory computer-readable medium described herein may further include operations, features, means, or instructions for determining a first value for a time gap between a synchronization signal block occasion and the valid PRACH occasion or the valid PUSCH occasion based on the synchronization signal block occasion being associated with a first control resource set pool index value and the valid PRACH occasion or the valid PUSCH occasion being associated with a second control resource set pool index value different from the first control resource set pool index value, the first value for the time gap different from a second value for the time gap associated with synchronization signal block occasion and the valid PRACH occasion or PUSCH occasion being associated with a same control resource set pool index value.

### BRIEF DESCRIPTION OF THE DRAWINGS

FIG. 1 illustrates an example of a wireless communications system that supports downlink reference timing determination for physical random access channel in multiple transmission reception point communications in accordance with one or more aspects of the present disclosure.

FIG. 2 illustrates an example of a network architecture that supports downlink reference timing determination for physical random access channel in multiple transmission reception point communications in accordance with one or more aspects of the present disclosure.

FIG. 3 illustrates an example of a wireless communications system that supports downlink reference timing determination for physical random access channel in multiple transmission reception point communications in accordance with one or more aspects of the present disclosure.

FIGS. 4A and 4B each illustrate an example of a timing diagram that supports downlink reference timing determination for physical random access channel in multiple transmission reception point communications in accordance with one or more aspects of the present disclosure.

FIG. 5 illustrates an example of a timing diagram that supports downlink reference timing determination for physical random access channel in multiple transmission reception point communications in accordance with one or more aspects of the present disclosure.

FIGS. 6A and 6B each illustrates an example of a timing diagram that supports downlink reference timing determination for physical random access channel in multiple transmission reception point communications in accordance with one or more aspects of the present disclosure.

FIG. 7 illustrates an example of a process flow that supports downlink reference timing determination for physical random access channel in multiple transmission reception point communications in accordance with one or more aspects of the present disclosure.

FIGS. 8 and 9 show block diagrams of devices that support downlink reference timing determination for physical random access channel in multiple transmission reception point communications in accordance with one or more aspects of the present disclosure.

FIG. 10 shows a block diagram of a communications manager that supports downlink reference timing determination for physical random access channel in multiple transmission reception point communications in accordance with one or more aspects of the present disclosure.

FIG. 11 shows a diagram of a system including a device that supports downlink reference timing determination for physical random access channel in multiple transmission reception point communications in accordance with one or more aspects of the present disclosure.

FIGS. 12 through 14 show flowcharts illustrating methods that support downlink reference timing determination for physical random access channel in multiple transmission reception point communications in accordance with one or more aspects of the present disclosure.

### DETAILED DESCRIPTION

To avoid interference between downlink (DL) and uplink (UL), a user equipment (UE) uses a timing advance (TA) applicable to its UL transmissions. A network entity measures a time difference between reception of UL signals from the UE (e.g., physical uplink shared channel (PUSCH), physical uplink control channel (PUCCH), and/or sounding reference signal (SRS)) and sends TA commands to the UE based on a comparison of the time of arrival at the base station of the UL signals and a time kept at the network entity (e.g., a subframe time). The network entity may then send TA commands to the UE, each TA command indicating whether to delay more or less than a current delay, i.e., increase or decrease the TA. In multiple transmission reception point (mTRP) operation, the UE may communicate with two or more physically separated TRPs that are associated with a single serving cell of the network entity, each TRP using a different timing advance. A UE may also be configured to receive separate or distinct downlink control information (DCI) to schedule communications via each TRP. This mode is called multi-DCI (mDCI).

When a UE performs a random access channel procedure (also referred to as RACH) with the serving cell for mTRP operation, a first transmission of the RACH (e.g., Msg1 preamble (PRACH) for 4-step RACH, or Message A preamble/PUSCH for 2-step RACH) may be sent to either or both TRPs. The TA to be used is based on two values, the TA and a TA offset. For RACH, the TA used is 0. However, the value of TA offset to be used is unclear in the situation of mTRP operation where each TRP may use a different timing advance, for example due to different propagation delays.

A UE may be configured to operate according to an mTRP configuration using mDCI. The UE then knows, based on using the mDCI and mTRP configuration, a TA offset that the UE is to use, specific to the mDCI and mTRP configuration (or operation). The UE can then proceed to perform RACH using the TA offset specific to mDCI and mTRP configuration, in particular, transmitting the preamble/PRACH according to a timing that is based on the TA offset.

The TA offset for PRACH may be the same value shared across TRPs. For example, the gap between the preamble (e.g., RACH preamble) and UL transmission (PUSCH/PUCCH/SRS) may depend on whether the preamble and UL transmissions are associated with the same DL reference timing and same timing advance offset (e.g., n-TimingAdvanceOffset) value, or different values. Additionally, or alternatively, the gap between the preamble (RACH preamble) and a synchronization signal block (SSB) may depend on whether the control resource set pool index (e.g., CORESETPoolIndex) value for the SSB is different than for the preamble.

Additionally, or alternatively, each TRP may have its own associated TA offset value for PRACH. In this case, the gap between the preamble and UL transmission may depend on whether the preamble and UL transmissions are associated with the same or different control resource set pool index value. For single cell operation (or carrier aggregation in a same frequency band), the gap between the preamble (e.g., RACH preamble) and the UL transmission may be at least a threshold quantity of symbols or slots. In some examples, if separate reference timings are applied to the preambles for the different TRPs, the gap size may depend on whether the SSB and/or UL transmissions are associated with the same or different control resource set pool index values.

Aspects of the disclosure are initially described in the context of wireless communications systems. Aspects of the disclosure may be described with reference to timing diagrams that relate to downlink reference timing determination for physical random access channel in multiple transmission reception point communications. Aspects of the disclosure are further illustrated by and described with reference to apparatus diagrams, system diagrams, and flowcharts that relate to downlink reference timing determination for physical random access channel in multiple transmission reception point communications.

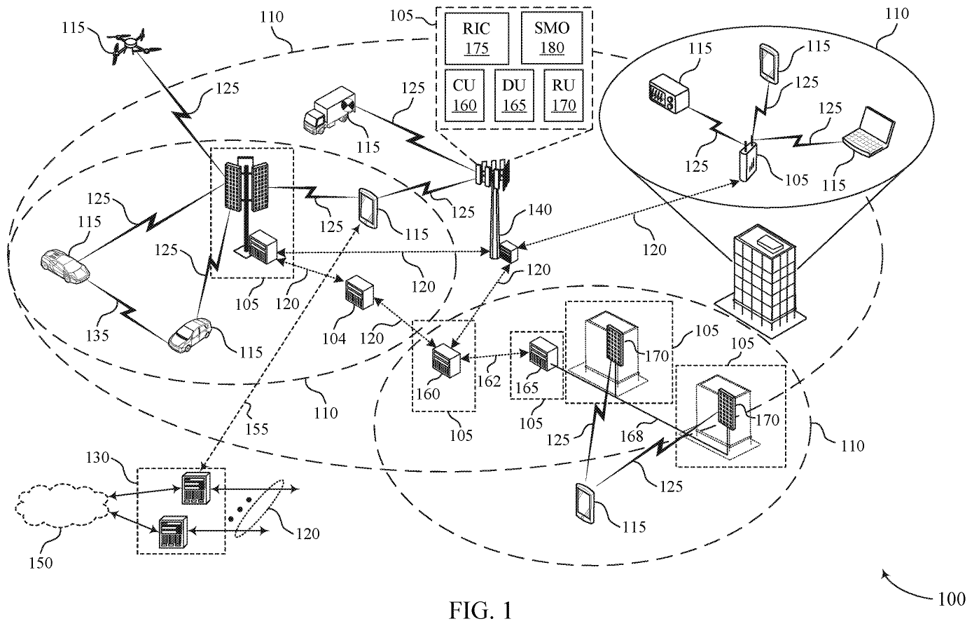

FIG. 1 illustrates an example of a wireless communications system 100 that supports downlink reference timing determination for physical random access channel in multiple transmission reception point communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support downlink reference timing determination for physical random access channel in multiple transmission reception point communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum, and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A UE may receive control signaling indicating two control resource set pool index values in an active bandwidth part of at least one serving cell. The two timing advance groups may be each associated with a timing advance offset for the serving cell. The UE may determine two downlink reference timings as the reference timing for uplink transmission. Each downlink reference timing may be associated with a timing advance group identity. The UE may then determine the uplink timing for a physical random access channel or physical uplink shared channel of a message A based on one or both of the two timing advance offsets, and one or both of the two downlink reference timings, then transmit a preamble in accordance with the determined uplink timing.

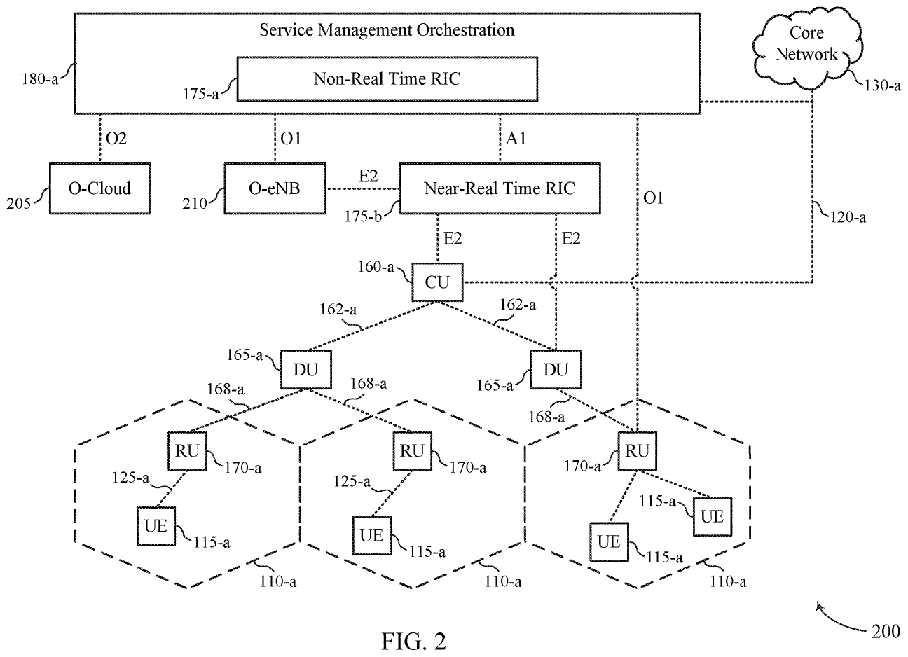

FIG. 2 illustrates an example of a network architecture 200 (e.g., a disaggregated base station architecture, a disaggregated RAN architecture) that supports downlink reference timing determination for physical random access channel in multiple transmission reception point communications in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage usage which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., AI policies).

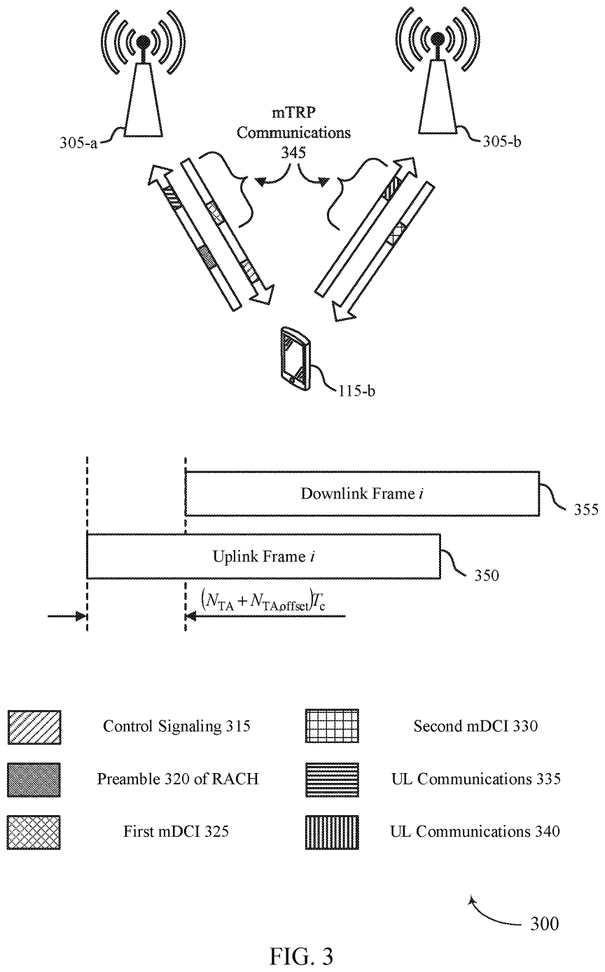

FIG. 3 illustrates an example of a wireless communications system 300 that supports downlink reference timing determination for physical random access channel in multiple transmission reception point (mTRP) communications in accordance with one or more aspects of the present disclosure.

A first TRP 305-a and a second TRP 305-b may be configured to communication with a UE 115-b. The UE 115-b may use a first TA for uplink communications with the first TRP 305-a, and a second TA for uplink communications with the second TRP 305-b. According to some present techniques, per-TRP TA is supported to handle the largely different propagation delays to the two TRPs, for example in the case of mDCI for mTRP communications 345. Techniques may be desired to support the use of two TAs for both intra-cell and inter-cell multi-DCI (mDCI) and multi-TRP (mTRP) scenarios.

For multi-DCI multi-TRP operation with two TAs, different scenarios may be considered. In one example, two reference timings may be used. In another example, one reference timing may be used. As such, for multi-DCI multi-TRP operation with two TAs, up to two timing advance offset values (e.g., n-TimingAdvanceOffset value) per serving cell may be supported.

In one example, an uplink frame 350 number i for transmission from the UE may start T_{TA}=(N_{TA}+N_{TA,offset}) T_{c} before the start of the corresponding downlink frame 355 number i at the UE where N_{TA,offset} may have a pre-set or configured value, for example indicated by correspondence table known to the UE 115-b, except for msgA transmission on PUSCH where a value of N_{TA}=0 may be used (e.g., UE 115-b may use the value of 0). For a PRACH transmission, N_{TA}=0 may be used (or required to be used) by UE 115-1 in order to get or acquire the initial TA.

In some examples, for single cell operation or for operation with carrier aggregation in a same frequency band, a UE 115-b may not transmit PRACH and PUSCH/PUCCH/SRS in a same slot or when a gap between the first or last symbol of a PRACH transmission in a first slot is separated by less than N symbols from the last or first symbol, respectively, of a PUSCH/PUCCH/SRS transmission in a second slot where N=2 for μ=0 or μ=1, N=4 for μ=2 or μ=3, N=16 for μ=5, N=32 for μ=6, and μ is the subcarrier spacing (SCS) configuration for the active UL BWP. For a PUSCH transmission with repetition Type B, this may apply to each actual repetition for PUSCH transmission. In some examples, the SCS for the active UL BWP may be 15 kHz. As such, in one example, where the gap is less than 2 symbols, the UE 115-b may not transmit PRACH and PUSCH/PUCCH/SRS. In another example, where the gap is larger than 2 symbols, the UE 115-b may transmit PRACH and PUSCH/PUCCH/SRS.

In some examples, for single TA, the DL reference timing for PRACH/msgA PUSCH and PUSCH/PUCCH/SRS is the same, the gap is related to UL TA difference between PRACH/msgA PUSCH and PUSCH/PUCCH/SRS. For PRACH/msgA PUSCH, the transmission may start T_{TA1}=N_{TA,offset}*T_{c} before the corresponding DL reference timing. For PUSCH/PUCCH/SRS, the transmission may start T_{TA2}=(N_{TA}+N_{TA,offset})*T_{c} before the corresponding DL reference timing. In some examples, assuming the last symbol of PRACH or msgA PUSCH ends at t₁, the first symbol of PUSCH/PUCCH/SRS starts at t₂, where t₁ and t₂ are logical time. To avoid overlapping between PRACH/msgA PUSCH and PUSCH/PUCCH/SRS, the actual ending position of PRACH or msgA PUSCH may be no later than the starting position of PUSCH/PUCCH/SRS, i.e., T_{Rx}−T_{Tx1}+t₁−T_{TA1}≤T_{Rx}−T_{Tx2}+t₂−T_{TA2}. Therefore, t₂−t₁≥(T_{TA2}−T_{TA1})+(T_{Tx2}−T_{Tx1}). In one example, for a single component carrier (CC), T_{Tx2}−T_{Tx1}=0. As such, in some examples, if the gap is larger than 2 symbols, the UE 115-b may transmit PRACH and PUSCH/PUCCH/SRS.

In some examples, for unpaired spectrum (e.g., unpaired radio frequency spectrum bands), if a UE is not provided tdd-UL-DL-ConfigurationCommon, a PRACH occasion in a PRACH slot is valid if it does not precede a SS/PBCH block in the PRACH slot and starts at least N_{gap} symbols after a last SS/PBCH block reception symbol, where N_{gap} is provided in Table 8.1-2 and, if channelAccessMode=“semiStatic” is provided, does not overlap with a set of consecutive symbols before the start of a next channel occupancy time where the UE does not transmit. In such examples, the candidate SS/PBCH block index of the SS/PBCH block may correspond to the SS/PBCH block index provided by ssb-PositionsInBurst in SIBI or in ServingCellConfigCommon.

In some examples, which may be in the context of a gap between an SSB and a PRACH, if a UE is provided tdd-UL-DL-ConfigurationCommon, a PRACH occasion in a PRACH slot is valid if it is within UL symbols, or it does not precede a SS/PBCH block in the PRACH slot and starts at least N_{gap} symbols after a last downlink symbol and at least N_{gap} symbols after a last SS/PBCH block symbol, where N_{gap} is provided in Table 8.1-2, and if channelAccessMode=“semiStatic” is provided, does not overlap with a set of consecutive symbols before the start of a next channel occupancy time where there may not be any transmissions. In such examples, the candidate SS/PBCH block index of the SS/PBCH block corresponds to the SS/PBCH block index provided by ssb-PositionsInBurst in SIBI or in ServingCellConfigCommon.

In some examples, which may be in the context of a gap between an SSB and a msgA PUSCH, a PUSCH occasion is valid if it does not overlap in time and frequency with any valid PRACH occasion associated with either a Type-1 random access procedure or a Type-2 random access procedure. Additionally, for unpaired spectrum and for SS/PBCH blocks with indexes provided by ssb-PositionsInBurst in SIBI or by ServingCellConfigCommon. In such examples, if a UE is not provided tdd-UL-DL-ConfigurationCommon, a PUSCH occasion is valid if the PUSCH occasion, or does not precede a SS/PBCH block in the PUSCH slot, and starts at least N_{gap} symbols after a last SS/PBCH block symbol, where N_{gap} is provided at the UE 115-b, for example by configuration and, if channelAccessMode=“semiStatic” is provided, does not overlap with a set of consecutive symbols before the start of a next channel occupancy time where the UE does not transmit.

In some examples, if a UE is provided tdd-UL-DL-ConfigurationCommon, a PUSCH occasion is valid if the PUSCH occasion is within UL symbols, or does not precede a SS/PBCH block in the PUSCH slot, and starts at least N_{gap} symbols after a last downlink symbol and at least N_{gap} symbols after a last SS/PBCH block symbol, where N_{gap} is provided by configuration or, for example in a table, and, if channelAccessMode=“semiStatic” is provided, does not overlap with a set of consecutive symbols before the start of a next channel occupancy time where the UE does not transmit.

In some examples, to avoid DL-to-UL interference, the gap between SSB and PRACH/msgA PUSCH may consider the DL propagation delay and UL TA. For PRACH/msgA PUSCH, the transmission starts T_{TA}=N_{TA,offset}*T_{c} before the corresponding DL reference timing. Assuming the last symbol of SSB ends at t₁, the first symbol of PRACH/msgA PUSCH starts at t₂, where t₁ and t₂ are logical time. To avoid DL-to-UL interference, the actual ending position of SSB should be no later than the starting position of PRACH/msgA PUSCH, i.e., T_{Rx}−T_{Tx1}+t₁+d/c≤T_{Rx}−T_{Tx2}+t₂−T_{TA}. Therefore, t₂−t₁≥d/c+T_{TA}+(T_{Tx2}−T_{Tx1}), where d is the maximum distance between gNB and UE, c is the velocity of light. If SSB and PRACH/msgA are in the same carrier, T_{Tx2}−T_{Tx1}=0.

In some additional examples, the values of N_{gap} may be configured as in the follow Table 1:

| Preamble SCS | N_{gap} |
|---|---|
| 1.25 kHz or 5 kHz | 0 |
| 15 kHz or 30 kHz or 60 kHz or 120 kHz | 2 |
| 480 kHz | 8 |
| 960 kHz | 16 |

In the context of wireless communications system 300, UE 115-b may receive control signaling 315 indicating two control resource set pool index values in an active bandwidth part of at least one serving cell. For example, TRP 305-a and TRP 305-b may be part of the serving cell, and a first control resource set pool may be associated with TRP 305-a and a second control resource set pool may be associated with TRP 305-b. Two timing advance groups may be each associated with a timing advance offset for the serving cell. The UE 115-b may determine two downlink reference timings as the reference timing for uplink transmission. Each downlink reference timing may be associated with a timing advance group identity. The UE 115-b may then determine the uplink timing for a PRACH (e.g., a PRACH preamble) or physical uplink shared channel of a message A based on at least one of the two timing advance offsets, at least one of the two downlink reference timings, or any combination thereof. UE 115-b may then transmit a preamble 320 (e.g., in a PRACH occasion or msgA PUSCH) in accordance with the determined uplink timing. Once the random access procedure is concluded, the UE 115-b may receive scheduling information for the serving cell via TRP 305-a (e.g., a first mDCI 325) and proceed to communicate on the UL with UL communications 335, and the UE 115-b may receive scheduling information for the serving cell via TRP 305-b (e.g., a second mDCI 330) and proceed to communication on the UL with UL communications 340.

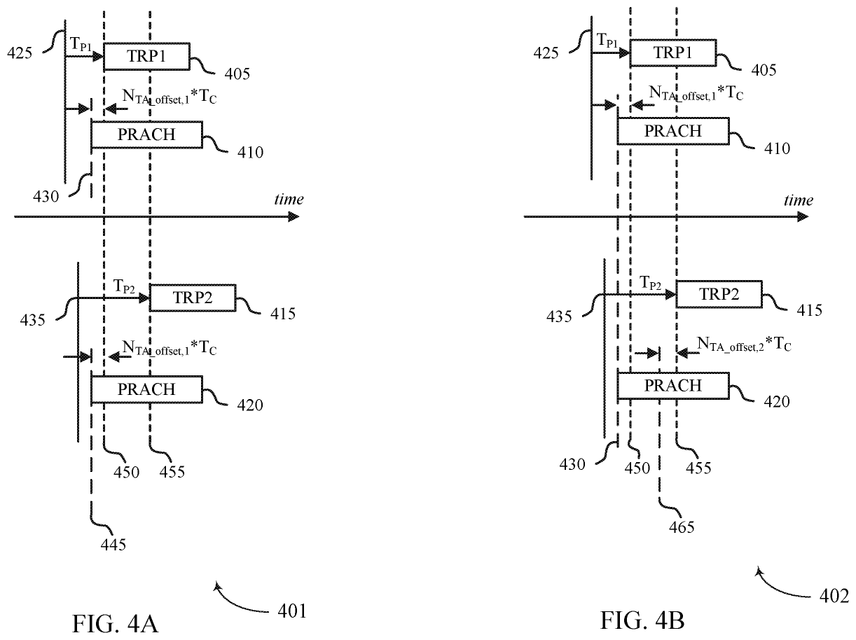

FIG. 4A illustrate an example of a timing diagram 401 that supports downlink reference timing determination for physical random access channel in multiple transmission reception point communications in accordance with one or more aspects of the present disclosure. The timing diagram 401 may be implemented by a UE 115 and/or a network entity 105 as described with respect to FIG. 1. More particularly, a UE 115 may implement the timing diagram 401 in order to determine an initial timing advance for a PRACH transmission and/or a msgA transmission on a PUSCH when the UE is configured with two control resource set pool index values in an active bandwidth part of a serving cell.

For PRACH transmission and msgA transmission, N_{TA}=0. However, for mDCI mTRP modes, as described herein, two downlink reference timings and two different timing advance offsets (e.g., n-TimingAdvanceOffset values) may be configured. Additionally, the devices may implement a PRACH per TRP of the mTRPs to identify the initial TA for each TRP. The PRACH transmission for different TRPs may be parallel or non-parallel. As noted, since two timing advance offset values may be supported per CC, two downlink reference timings for uplink transmissions may also be supported. Timing diagram 401 illustrates example techniques that may be used to determine the uplink transmission timing for PRACH or msgA PUSCH.

According to a first option for determining the uplink transmission timing for PRACH or msgA PUSCH transmission associated with different CORSETPoolIndex values (where each index corresponds to a respective TRP), the PRACH timing may be determined based on a single DL reference timing and a single timing advance offset value (e.g., n-TimingAdvanceOffset value). That is, even if two (or more) downlink reference timings and two (or more) timing advance offset values exist for a CC, a single downlink reference timing and a single timing advance offset value may be used for the PRACH or msgA PUSCH transmission, which may support PRACH transmission alignment (between two TRPs) and reduced complexity at a UE. In such cases, there may be multiple techniques for determining the downlink reference timing and the timing offset value to use for the PRACH or msgA PUSCH transmission. According to a first example of this option, the single downlink reference timing is determined as the earlier downlink reference timing among the two downlink reference timings. The single timing advance offset value is associated with the same timing advance group (TAG) as the single downlink reference timing (the earliest downlink reference timing). According to a second example of this option, the single downlink reference timing is determined as the downlink reference timing associated with a specific CORSETPoolIndex value (e.g., the first, smaller, later, or larger CORSETPoolIndex value). In such cases, the single timing advance offset value may be determined as the timing advance offset value associated with the same TAG as the determined downlink reference timing. As such, in both of these examples, the downlink reference timing is determined, then the timing advance offset is determined based on the determined downlink reference timing.

As illustrated in timing diagram 401, the UE selects the downlink reference timing as either downlink reference timing 450 for TRP1 or downlink reference timing 455 for TRP 2 based on either the earlier downlink reference timing or the downlink reference timing associated with a CORSETPoolIndex value (e.g., the first or smaller value). Thus, in case of selection of the downlink reference timing 450 for TRP1, then the UE selects the timing advance offset (e.g., N_{TA_offset,1}) that is associated with the same TAG as TRP1. As described, the downlink reference timing 450 or 455 is based on a time of receipt of a transmission from a TRP. Thus, the TRP1 transmits the downlink transmission 405 at 425, which is received at the UE at downlink reference timing 450 and offset from the transmission time as T_{P1}. Similarly, the TRP2 transmits the downlink transmission 415 at 435, which is received at the UE at downlink reference timing 455 and offset from the transmission time as T_{P2}.

If the UE uses the downlink reference timing 450 (e.g., as the earliest downlink reference timing or a lowest CORSETPoolIndex value) and the corresponding timing advance offset, the UE may determine a timing 430 of PRACH transmission 410 for TRP1 and a timing 445 of PRACH transmission 420 for TRP2, which are aligned (e.g., timing 430 and 445 are aligned). Note that downlink reference timing 455 and the corresponding timing advance offset for downlink transmission 415 of TRP2 may also be used for determining the PRACH timing for both TRPs. Note that in the example of timing diagram 401 the PRACH transmission 410 and the PRACH transmission 420 may instead be msgA transmissions, and the timing of the msgA transmissions may be determined as described with respect to the timing diagram 401.

FIG. 4B illustrates an example of a timing diagram 402 that supports downlink reference timing determination for physical random access channel in multiple transmission reception point communications in accordance with one or more aspects of the present disclosure. As described with respect to FIG. 4A, a UE may implement timing diagram 402 in order to determine an initial timing advance for a PRACH transmission and/or a msgA transmission on a PUSCH when the UE is configured with two control resource set pool index values in an active bandwidth part of a serving cell.

Specifically, timing diagram 402 illustrates a third example of using a single downlink reference timing and a single timing advance offset value for PRACH transmission. In the illustrated example, the UE may calculate the timing of the PRACH transmission (or timing of msgA transmission) using both sets of parameters (e.g., a first and second downlink reference timing and a first and second timing advance offset value), and then select the earliest (or latest) PRACH/msgA timing to transmit both transmissions to each of the TRPs.

Similarly, as described with respect to timing diagram 401 of FIG. 4A, the UE determines the downlink reference timing 450 for the downlink transmission 405 of TRP1 and the downlink reference timing 455 for downlink transmission 415 corresponding to TRP2. The UE also determines the timing advance offset corresponding to the TAG of TRP1 and the timing advance offset corresponding to the TAG of TRP2. The UE then applies the timing advance offset for TRP1 to the downlink reference timing 450 and the timing advance offset for TRP2 to the downlink reference timing 455 to determine to respective PRACH (or msgA) timings (e.g., timing 430 using parameters corresponding to TRP1 and the downlink reference timing 465 using parameters corresponding to TRP2). The UE then selects the earliest (or latest) of the two determined timings for transmission of both PRACH transmission 410 and PRACH transmission 420. In the illustrated example, the UE selects timing 430 for transmission of both PRACH transmission 410 and PRACH transmission 420. Note that in the example of timing diagram 402 the PRACH transmission 410 and the PRACH transmission 420 may instead be msgA transmissions. As described with respect to FIG. 4A, even if two (or more) downlink reference timings and two (or more) timing advance offset values exist for a CC, a single downlink reference timing and a single timing advance offset value may be used for the PRACH or msgA PUSCH transmission, which may support PRACH transmission alignment (between two TRPs) and reduced complexity at a UE.

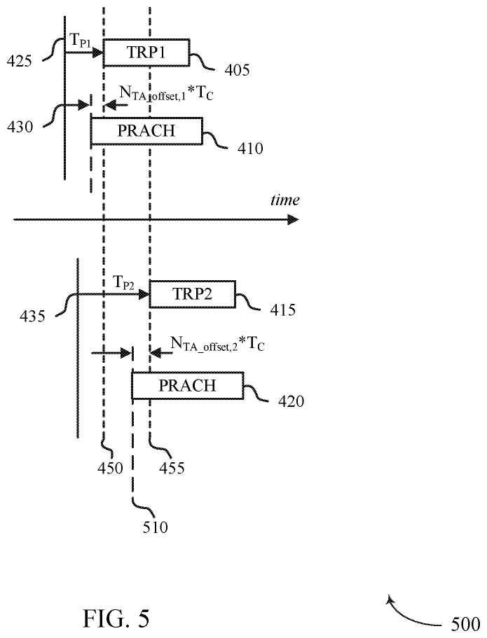

FIG. 5 illustrates an example of a timing diagram 500 that supports downlink reference timing determination for physical random access channel in multiple transmission reception point communications in accordance with one or more aspects of the present disclosure. The timing diagram 501 may be implemented by a UE 115 and/or a network entity 105 as described with respect to FIG. 1. More particularly, a UE 115 may implement the timing diagram 501 in order to determine an initial timing advance for a PRACH transmission and/or a msgA transmission on a PUSCH when the UE is configured with two control resource set pool index values in an active bandwidth part of a serving cell.

In the example of timing diagram 500 of FIG. 5, the UE may be configured with different CORSETPoolIndex values corresponding to separate TRPs. Instead of selecting one downlink timing reference and one timing advance offset value (as described with respect to FIG. 4A and FIG. 4B), the UE may use each downlink timing reference and timing advance offset values to determine separate PRACH transmission or msgA PUSCH timings corresponding to each TRP.

Thus, as described with respect to FIG. 4, the UE determines downlink reference timing 450 for downlink transmission 405 for TRP1 and downlink reference timing 455 for downlink transmission 415 corresponding to TRP2. In the illustrated example, the downlink reference timing of the given CORESETPoolIndex value associated with the corresponding PRACH transmission or msgA transmission or the downlink reference timing associated with a TAG that is associated with the same CORESETPoolIndex value as the PRACH transmission or msgA transmission is used. Similarly, the timing advance offset value of a given CORSETPoolIndex value associated with the corresponding PRACH transmission or msgA transmission or the timing advance offset associated with a given TAG that is associated with the same CORESETPoolIndex value as the PRACH transmission or msgA transmission is used to determine the timing of the PRACH or msgA PUSCH transmission. Thus, the UE may determine timing 430 for PRACH transmission 410 corresponding to TRP1 and timing 510 for PRACH transmission 420 corresponding to TRP2. The example of FIG. 5 may result in misaligned PRACH transmissions for TRP1 and TRP2, which may result in increased UE complexities and power control considerations and improved signal diversity.

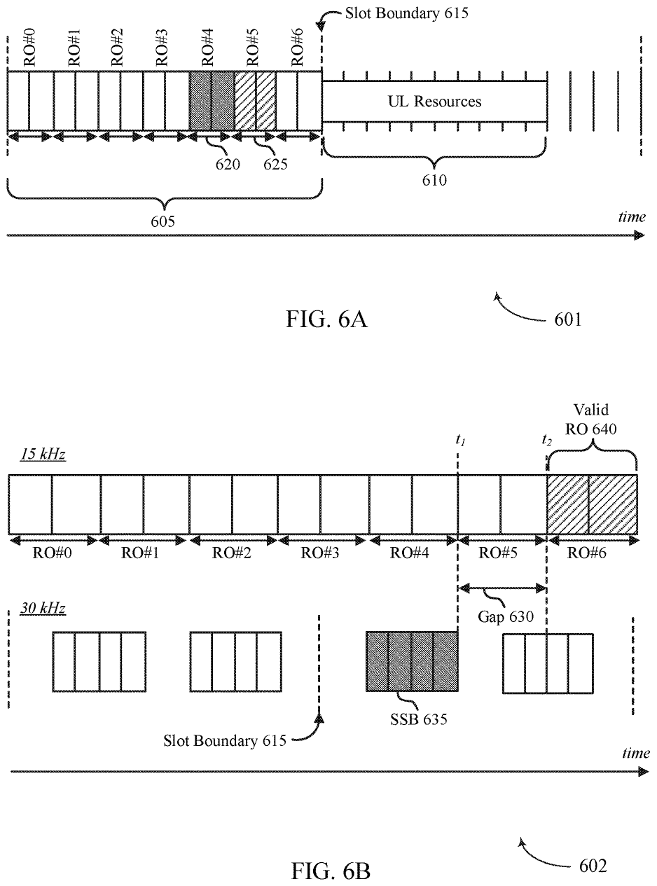

FIG. 6A illustrates an example of a timing diagram 601 that supports downlink reference timing determination for physical random access channel in multiple transmission reception point communications in accordance with one or more aspects of the present disclosure. The timing diagram 601 may be implemented by a UE 115 and/or a network entity 105 as described with respect to FIG. 1. More particularly, a UE 115 may implement the timing diagram 601 in order to determine to transmit a PRACH transmission or a msgA PUSCH transmission when operating in a mDCI and mTRP mode.

When the UE uses a single downlink reference timing for mTRP PRACH or msgA PUSCH (as described with respect to FIG. 4A and FIG. 4B) associated with a first CORESETPoolIndex value and two downlink reference timings are used for PUSCH, PUCCH, and/or SRS, then for PRACH or msgA PUSCH and PUSCH, PUCCH, or SRS that are associated with a second CORESETPoolIndex value, the downlink reference timing (and the timing advance offset) may be different. For PRACH or msgA PUSCH, the reference timing associated with the first CORESETPoolIndex value (e.g., first reference timing) is used, while for PUSCH/PUCCH/SRS, the reference timing associated with the second CORESETPoolIndex value (e.g., second reference timing) is used. In addition, the n-TimingAdvanceOffset value between PRACH/msgA PUSCH and PUSCH/PUCCH/SRS may also be different. Considering the above, the gap between PRACH/msgA PUSCH and PUSCH/PUCCH/SRS may be different from how a UE may determine the gap in other cases.

For PRACH/msgA PUSCH, the transmission starts T_{TA1}=N_{TA,offset,1}*T_{c} before the first DL reference timing. For PUSCH/PUCCH/SRS, the transmission starts T_{TA2}=(N_{TA}+N_{TA,offset,2})*T_{c} before the second DL reference timing. Assuming the last symbol of PRACH or msgA PUSCH ends at t₁, the first symbol of PUSCH/PUCCH/SRS starts at t₂, where t₁ and t₂ are logical time. To avoid overlapping between PRACH/msgA PUSCH and PUSCH/PUCCH/SRS, the actual ending position of PRACH or msgA PUSCH should be no later than the starting position of PUSCH/PUCCH/SRS, i.e., t₁+T_{Rx1}−T_{Tx1}−T_{TA1}≤t₂+T_{Rx2}−I_{Tx2}−T_{TA2}. Therefore, t₂−t₁≥(T_{TA2}−T_{TA1})+(T_{Tx2}−T_{Tx1})−(T_{Rx2}−T_{Rx1})=N_{TA}*T_{c}+(T_{Tx2}−T_{Tx1})+(N_{TA,offset,2}−N_{TA,offset,1})*T_{c}−(T_{Rx2}−T_{Rx1}), where T_{Rx2} is the DL reference timing of PUSCH/PUCCH/SRS, T_{Rx1} is the DL reference timing of PRACH/msgA PUSCH, N_{TA,offset,2} is the timing advance offset value of PUSCH/PUCCH/SRS, and N_{TA,offset,1} is the timing advance offset value of PRACH/msgA PUSCH

Similarly, when PRACH/msgA use a different reference timing detected from SSB, the gap between SSB and PRACH/msgA PUSCH may also be different from the existing spec. For PRACH/msgA PUSCH, the transmission starts T_{TA}=N_{TA,offset,x}*T_{c} before the corresponding DL reference timing. Assuming the last symbol of SSB ends at t₁, the first symbol of PRACH/msgA PUSCH starts at t₂, where t₁ and t₂ are logical time. To avoid DL-to-UL interference, the actual ending position of SSB should be no later than the starting position of PRACH/msgA PUSCH, i.e., t₁+T_{Rx1}−T_{Tx1}+d/c≤t₂+T_{Rx2}−T_{Tx2}−T. Therefore, t₂−t₁≥d/c+T_{TA}+(T_{Tx2}+T_{Tx1})−(T_{Rx2}−T_{Rx1}), where d is the maximum distance between gNB and UE, and c is the velocity of light (e.g., d/c is the downlink propagation delay). As such, due to the differences in the downlink reference timing, the gap between the SSB and the PRACH or msgA may be determined differently than the gap between SSB and PRACH associated with the same downlink reference timing.

Thus, in some cases, the PRACH or msgA downlink timing reference is the same as the downlink timing reference PUSCH, PUCCH, or SRS even when selecting between two downlink timing references for PRACH or msgA PUSCH transmissions as described with respect to FIG. 4A and FIG. 4B. In such cases, the UE may determine the gap as set forth herein with respect to FIG. 3. However, in some examples, the UE may determine different downlink timing references for the PRACH or msgA PUSCH transmission and the PUSCH, PUCCH, or SRS using the techniques described with respect to FIG. 4A and FIG. 4B. In such cases (e.g., the PRACH/msgA PUSCH and PUSCH/PUCCH/SRS are associated with different downlink reference timings) then the UE may not transmit the PRACH/msgA PUSCH and the uplink transmission in the same slot or may use various techniques to determine the gap (e.g., a time gap value or threshold) that is used to determine whether to transmit the PRACH/msgA PUSCH and the uplink transmissions in different slots.

According to one technique for determining the gap, a new value N′, may be used, where N′ may be configured per SCS. If (N_{TA,offset,2}−N_{TA,offset,1})*T_{c}−(T_{Rx2}−T_{Rx1})<0, N′ is smaller than N, where Nis the existing gap. If (N_{TA,offset,2}−N_{TA,offset,1})*T_{c}−(T_{Rx2}>−T_{Rx1})>0, N′ is larger than N, where N is the existing gap. According to another technique, an additional gap value Δ_{N} is used with the existing gap N between PRACH/msgA PUSCH and PUSCH/PUCCH/SRS. Δ_{N} is determined based on N_{TA,offset,2}−N_{TA,offset,1} and T_{Rx2}−T_{Rx1.}Δ_{N} is per SCS or per band. As such, the new gap is equal to N+Δ_{N} when the UE determines different downlink reference timing for PRACH/msgA and PUSCH, PUCCH, SRS.

Thus, the UE may apply the one of these gap values (e.g., N′ or N+Δ_{N}) to determine whether to transmit the PRACH/msgA PUSCH and PUSCH, PUCCH, or SRS in a different slots. According to one implementation for single cell operation or for operation with carrier aggregation in a same frequency band, if PRACH/msgA PUSCH and PUSCH/PUCCH/SRS are associated with different downlink reference timing and/or different n-TimingAdvanceOffset value, a UE does not transmit PRACH/msgA PUSCH and PUSCH/PUCCH/SRS in a same slot or when a gap between the first or last symbol of a PRACH transmission in a first slot is separated by less than N′ symbols from the last or first symbol, respectively, of a PUSCH/PUCCH/SRS transmission in a second slot. According to a second implementation for single cell operation or for operation with carrier aggregation in a same frequency band, if PRACH/msgA PUSCH and PUSCH/PUCCH/SRS are associated with different downlink reference timing and/or different n-TimingAdvanceOffset value, a UE does not transmit PRACH/msgA PUSCH and PUSCH/PUCCH/SRS in a same slot or when a gap between the first or last symbol of a PRACH transmission in a first slot is separated by less than N+Δ_{N} symbols from the last or first symbol, respectively, of a PUSCH/PUCCH/SRS transmission in a second slot. If PRACH/msgA PUSCH and PUSCH/PUCCH/SRS are associated with different CORESETPoolIndex values and different downlink reference timings, these rules are applicable when simultaneous transmission between PRACH/msgA PUSCH and PUSCH/PUCCH/SRS is not supported.

Application of these gap rules is illustrated with respect to FIG. 6A. In timing diagram 601 of FIG. 6A, a slot boundary 615 is positioned between a set of RACH occasions 605 and a set of uplink resources 610. According to a first scenario, the UE determines the same downlink reference timing between the PRACH (or msgA) and the PUSCH, PUCCH, or SRS transmission and the UE selects RACH occasion (RO) 625. In such cases, N=2 and the UE may transmit the PRACH (or msgA) in RACH occasion 625 and the PUSCH, PUCCH, or SRS in the uplink resources 610 since the N=2 gap threshold is not violated. In a second scenario, the UE determines different downlink reference timings between the PRACH (or msgA) and the PUSCH, PUCCH, or SRS transmission and the UE selects RACH occasion (RO) 625. In this example, N′=3 (or N=2 and Δ_{N}=1) and the gap between the RACH occasion 625 is less than 3 symbols, and as such, the UE does not transmit the PRACH and the PUSCH/PUCCH/SRS.

According to a third scenario, the UE determines different downlink reference timings between the PRACH (or msgA) and the PUSCH, PUCCH, or SRS transmission and the UE selects RACH occasion (RO) 620. In this example, N′=3 (or N=2 and Δ_{N}=1) and the gap between the RACH occasion 620 is more than 3 symbols, and as such, the UE does transmit the PRACH in the RACH occasion 620 and the PUSCH/PUCCH/SRS in the uplink resources 610.

As described with respect to FIG. 5, TRP-specific PRACH timing may be applied by a UE. For PRACH/msgA PUSCH and PUSCH/PUCCH/SRS associated with the same TRPs or CORESETPoolIndex values, same downlink reference timing (and same timing advance offset) will be used. For PRACH/msgA PUSCH and PUSCH/PUCCH/SRS associated with different TRPs or CORESETPoolIndex values, different downlink reference timings may be used. Similar to as described with respect to FIG. 6A, a new gap between PRACH/msgA PUSCH and PUSCH/PUCCH/SRS, as well as the gap between SSB and PRACH/msgA PUSCH may be introduced when the PRACH/msgA are associated with different TRP, as described with respect to FIG. 6B.

Thus, the gap threshold N′ or N+Δ_{N} may be used or applied when PRACH/msgA and PUSCH/PUCCH/SRS are associated with different CORSETPoolIndex values. The gap threshold N may be used or applied when PRACH/msgA and PUSCH/PUCCH/SRS are associated with the same CORESETPoolIndex values. That is, for single cell operation or for operation with carrier aggregation in a same frequency band, if PRACH/msgA PUSCH and PUSCH/PUCCH/SRS are associated with same CORESETPoolIndex value, a UE does not transmit PRACH/msgA PUSCH and PUSCH/PUCCH/SRS in a same slot or when a gap between the first or last symbol of a PRACH transmission in a first slot is separated by less than N symbols from the last or first symbol, respectively, of a PUSCH/PUCCH/SRS transmission (e.g., uplink transmission) in a second slot. Further, for single cell operation or for operation with carrier aggregation in a same frequency band, if PRACH/msgA PUSCH and PUSCH/PUCCH/SRS are associated with different CORESETPoolIndex values, a UE does not transmit PRACH/msgA PUSCH and PUSCH/PUCCH/SRS in a same slot or when a gap between the first or last symbol of a PRACH transmission in a first slot is separated by less than N′ or N+Δ_{N} symbols from the last or first symbol, respectively, of a PUSCH/PUCCH/SRS transmission in a second slot. This rule (e.g., the new gap configuration and slot consideration) may be applied when simultaneous transmissions between PRACH/msgA PUSCH and PUSCH/PUCCH/SRS across different CORESETPoolIndex values are not supported.

Thus, in FIG. 6A, if the PRACH/msgA of RACH occasion 625 and the uplink resources (e.g., PUSCH/PUCCH/SRS) are associated with a same CORSETPoolIndex value, then the gap is equal to 2 symbols, and as such, the UE may transmit the PRACH in RACH occasion 625 and the PUSCH/PUCCH/SRS in the uplink resources 610. If, however, the PRACH/msgA of RACH occasion 625 and the uplink resources are associated with different CORESETPoolIndex values, then the gap is less than three symbols (e.g., N′=3 or N=2 and Δ_{N}=1), the UE does not transmit the PRACH in the RACH occasion 625 and the PUSCH/PUCCH/SRS in the uplink resources 610. In another example, if the PRACH/msgA of RACH occasion 620 and the uplink resources are associated with different CORESETPoolIndex values, then the gap is more than three symbols (e.g., N′=3 or N=2 and Δ_{N}=1), the UE may transmit the PRACH in the RACH occasion 620 and the PUSCH/PUCCH/SRS in the uplink resources 610. Implementations illustrated in FIG. 6A are described with respect to determine whether a RACH occasion (e.g., RACH occasion 620) is valid by considering whether the uplink transmission and RACH occasion are in the same slot or whether the distance between the RACH occasion and the uplink transmission are less than a gap threshold. However, it should be understood that these techniques are applicable in considering the validity of a PUSCH occasion (for transmission of a PUSCH of msgA) in relation to an uplink transmission (e.g., PUSCH, PUSCH, or SRS).

FIG. 6B illustrates an example of a timing diagram 602 that supports downlink reference timing determination for physical random access channel in multiple transmission reception point communications in accordance with one or more aspects of the present disclosure. The timing diagram 602 may be implemented by a UE 115 and/or a network entity 105 as described with respect to FIG. 1. More particularly, a UE 115 may implement the timing diagram 602 to determine whether to transmit a PRACH transmission or a msgA PUSCH transmission when operating in a mDCI and mTRP mode and/or to determine whether a PRACH occasion or PUSCH occasion is valid.

As described herein, a UE may determine to use a PRACH/msgA PUSCH reference timing that is the same as a reference timing detected from a SSB associated with a CORESETPoolIndex value or different from the CORESETPoolIndex value associated with the SSB. That is, the UE may use the downlink reference timing for PRACH/msgA that is associated with a CORESETPoolIndex value that is different from a downlink reference timing for a CORESETPoolIndex value for a detected SSB. In such cases, a new gap a new value N_{gap}′ for the gap between SSB and PRACH/msgA PUSCH or a Δ_{gap} may be applied to determine whether a determined PRACH occasion is valid or not.

According to a first option, the new value N_{gap}′ for the gap between SSB and PRACH/msgA PUSCH. N_{gap}′ is applied and/or configured per SCS. If the reference timing of PRACH/msgA PUSCH is the earlier one among the two reference timings, N_{gap}′ is smaller than N_{gap}, where N_{gap} is the existing gap. If the reference timing of PRACH/msgA PUSCH is the later one among the two reference timings, N_{gap}′ is larger than N_{gap}, Where N_{gap} is the existing gap.

According to a second option, a new additional gap value Δ_{gap} may applied to the existing gap N_{gap} between SSB and PRACH/msgA PUSCH. In this example, Δ_{gap} is applied and/or configured per SCS or per band. If the reference timing of PRACH/msgA PUSCH is the earlier one, Δ_{N} is negative. If the reference timing of PRACH/msgA PUSCH is the later one, Δ_{N} is positive.

The UE may apply either of these new values to determine whether the PRACH occasion is valid. If the downlink reference timing associated with a given CORESETPoolIndex value is used for PRACH/msgA PUSCH and if an SSB is associated with the same CORESETPoolIndex value, a PRACH occasion in a PRACH slot is valid if it does not precede the SS/PBCH block in the PRACH slot and starts at least N_{gap} symbols after the last SS/PBCH block reception symbol, where N_{gap} is the existing gap. If the downlink reference timing associated with a first CORESETPoolIndex value is used for PRACH/msgA PUSCH and if an SSB is associated with a second CORESETPoolIndex value different from the first CORESETPoolIndex value, a PRACH occasion in a PRACH slot is valid if it does not precede the SS/PBCH block in the PRACH slot and starts at least

$${N}_{gap}^{′} or {N}_{gap}^{′} + {Δ}_{gap}$$

symbols after the last SS/PBCH block reception symbol, where

$${N}_{gap}^{′} or {N}_{gap}^{′} + {Δ}_{gap}$$

is the new gap.

Application of these gap rules is illustrated with respect to FIG. 6B. In timing diagram 602 of FIG. 6B. According to a first example, the determined downlink reference timing for the PRACH/msgA is associated CORSETPoolIndex 0 and an SSB 635 is also associated with CORESETPoolIndex 0. In this example, N=2, and the gap 630 between the SSB 635 and RACH occasion 640 is two symbols. As such, RACH occasion 640 is valid. In second example, the determined downlink reference timing for the PRACH/msgA is associated with CORESETPoolIndex 0, and the SSB 635 is associated with CORESETPoolIndex 1. In this example, the UE applies the new gap configuration, such as N_{gap}′=1, or N_{gap}=2, Δ_{gap}=−1. The gap 630 between the SSB 635 and the RACH occasion 640 is two symbols, which is larger than one symbol and results in the RACH occasion 640 being valid.

As described with respect to FIG. 5, a UE may determine to use PRACH or msgA PUSCH transmissions (for mTRPs) that are associated with different downlink reference timings and timing advance values, such that the PRACH transmissions are associated with different CORESETPoolIndex values. In such cases when SSB and PRACH/msgA PUSCH are associated with different CORESETPoolIndex values, the new gap configuration (N_{gap}′ or N_{gap}+Δ_{gap}) is applied. Thus, the UE considers whether a RACH occasion is valid or not. For example, if the N_{gap}=2 and N_{gap}′=3 and the SSB 635 is associated with CORSETPoolIndex 0, the RACH occasion 640 is valid if the PRACH is associated with the first CORESETPoolIndex value (e.g., the same value as the SSB 635), such that N_{gap} is applied. In the same example, the RACH occasion 640 is invalid (e.g., the UE will not use the RACH occasion 640) if the PRACH is associated with the second CORESETPoolIndex value such that N_{gap}′ is applied. Implementations illustrated in FIG. 6B are described with respect to determine whether a RACH occasion (e.g., RACH occasion 640) is valid by considering whether the distance between the RACH occasion and the SSB are less than a gap threshold. However, it should be understood that these techniques are applicable in considering a validity of a PUSCH occasion (for transmission of a PUSCH of msgA) in relation to the SSB.

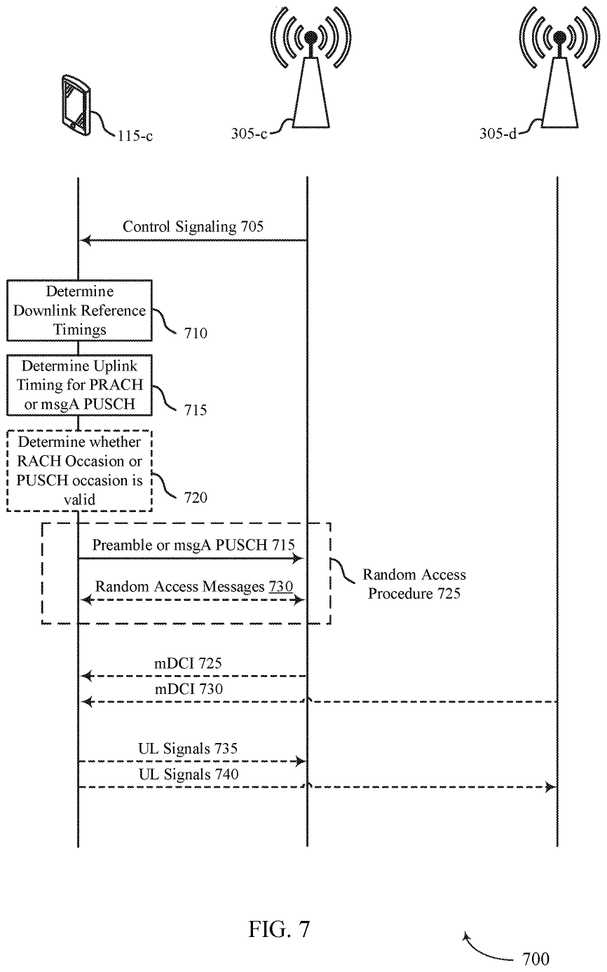

FIG. 7 illustrates an example of a process flow 700 that supports downlink reference timing determination for physical random access channel in multiple transmission reception point communications in accordance with one or more aspects of the present disclosure. The process flow 700 includes a UE 115-c, a TRP 305-c, and a TRP 305-d. The UE 115-c may be an example of a UE 115 as described with respect to FIGS. 1 through 3, and the TRP 305-c and the TRP 305-d may be examples of the TRPs 305 as described with respect to FIG. 3. The TRPs 305 may be associated with a same network entity 105, as described with respect to FIG. 1. In the following description of the process flow 700, the operations between UE 115-c and the TRPs 305-c and 305-d may be transmitted in a different order than the example order shown, or the operations performed may be performed in different orders or at different times. Some operations may also be omitted from the process flow 700, and other operations may be added to the process flow 700.

At 705, the UE 115-c may receive control signaling (from one or both TRPs 305-c and 305-d) indicating two control resource set pool index values (CORESETPoolIndex values) in an active bandwidth part of at least one serving cell. Two timing advance group, each associated with a timing advance offset, are configured for the serving cell.

At 710, the UE 115-c may determine two downlink reference timings for an uplink transmission within a serving cell. Two timing advance groups are each associated with a respective timing advance offset are configured for the serving cell. Each of the two downlink reference timings may be associated with a respective timing advance group of the two timing advance groups.

At 715, the UE 115-c may determine an uplink timing for a random access preamble of a physical random access channel (PRACH) or a message A of a physical uplink shared channel (PUSCH) based at least in part on at least one of the two timing advance offsets, at least one of the two downlink reference timings, or any combination thereof. In some examples, the UE 115-c may determine a single uplink timing for the PRACH or message A PUSCH based on a single downlink reference timing value and a single timing advance offset value. In some examples, the UE 115-c may identify the single timing advance offset based on the single downlink reference timing value among the two downlink reference timings. The UE 115-c may also select the single downlink reference timing value among the two downlink reference as an earliest in time among the two downlink reference timings. In other cases, the UE 115-c selects the single downlink reference timing value among the two downlink reference timings based on one of the two control resource pool index values (e.g., a lowest value). In other cases, the UE 115-c may select an earliest uplink timing for the uplink timings determined using respective sets of downlink reference values and timing advance offset values.

In some examples, at 720, the UE 115-c determines whether a RACH occasion or a PUSCH occasion of a random access procedure are valid. To determine whether the occasions are valid, the UE may determine the applicable time gap thresholds between an SSB and the RACH occasion or the PUSCH occasion and between the RACH occasion or the PUSCH occasion and uplink resource for carrying a PUSCH, PUCCH, or SRS.

The determination of the time gap threshold (in symbols) between the uplink resource and the PRACH occasion and the PUSCH occasion for message A may be based on whether the uplink resource is associated with a different reference timing and different timing advance offset than the PRACH occasion or the PUSCH occasion for message A or based on whether the uplink resource is associated with a different control resource set pool index than the control resource set pool index associated with the PRACH occasion or the PUSCH occasion for message A. If the gap between a RACH occasion or PUSCH occasion for message A and the uplink resource is less than the determined time gap, then the UE may refrain from transmitting using the uplink resource and the PRACH occasion or the PUSCH occasion. The UE may also refrain from transmitting in the same slot when the PRACH occasion or the message A PUSCH occasion and the uplink resources are associated with different downlink reference timing and/or different timing advance offset values or when the PRACH occasion or the message A PUSCH occasion and the uplink resources are associated with different control resource set index values.

The determination of the time gap threshold between a SSB occasion and the PRACH occasion or the PUSCH occasion for message A may be based at least in part on whether the SSB and the PRACH occasion or the PUSCH occasion for message A are associated with different control resource set pool index values. If the gap between the SSB and the PRACH occasion or the PUSCH occasion for message A is less than the determined time gap, then the UE may determine that the PRACH occasion or the PUSCH occasion for message A is invalid and refrain from transmitting in the PRACH occasion or PUSCH occasion for message A.

At 715, the UE 115-c may transmit as part of a random access procedure at 725, the random access preamble in a valid PRACH occasion or the message A in a valid PUSCH occasion in accordance with the determined uplink timing. At 730, the UE 115-c and one or both the TRPs 305-c and 305-d may exchange random access messages as part of the random access procedure at 725.

At 725, the UE 115-c may receive (e.g., in response to the random access procedure) an mDCI from the TRP 305-c, and at 730, the UE 115-c may receive an mDCI from the TRP 305-d. At 735, the UE 115-c may transmit one or more uplink signals to the TRP 305-c in accordance with the received mDCI (e.g., scheduling information in the mDCI). At 740, the UE 115-c may transmit one or more uplink signals to the TRP 305-d based on the mDCI.

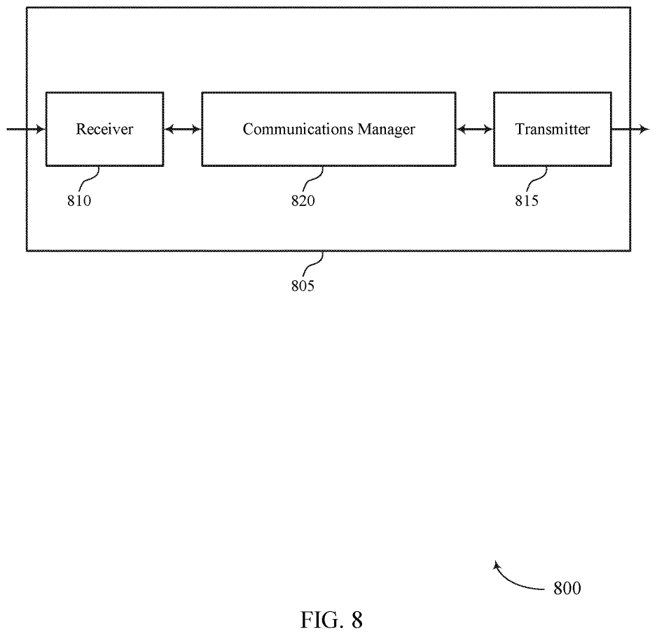

FIG. 8 shows a block diagram 800 of a device 805 that supports downlink reference timing determination for physical random access channel in multiple transmission reception point communications in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to downlink reference timing determination for physical random access channel in multiple transmission reception point communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to downlink reference timing determination for physical random access channel in multiple transmission reception point communications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of downlink reference timing determination for physical random access channel in multiple transmission reception point communications as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 may be configured as or otherwise support a means for determining two downlink reference timings for an uplink transmission within a serving cell, where two timing advance groups each associated with a respective timing advance offset are configured for the serving cell, and where each of the two downlink reference timings is associated with a respective timing advance group of the two timing advance groups. The communications manager 820 may be configured as or otherwise support a means for determining an uplink timing for a random access preamble of a physical random access channel (PRACH) or a message A of a physical uplink shared channel (PUSCH) based on at least one of the two timing advance offsets, at least one of the two downlink reference timings, or any combination thereof. The communications manager 820 may be configured as or otherwise support a means for transmitting, as part of a random access procedure, the random access preamble in a valid PRACH occasion or the message A in a valid PUSCH occasion in accordance with the determined uplink timing.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing by supporting the UE in determining timing advance values for random access preambles when the UE is operating according to a mDCI and MTRP mode.

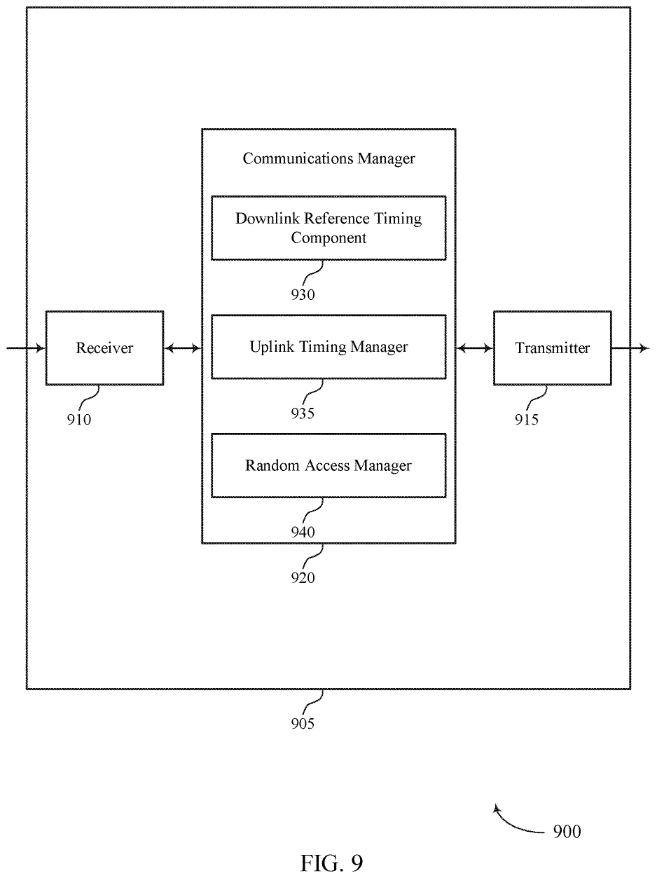

FIG. 9 shows a block diagram 900 of a device 905 that supports downlink reference timing determination for physical random access channel in multiple transmission reception point communications in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to downlink reference timing determination for physical random access channel in multiple transmission reception point communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to downlink reference timing determination for physical random access channel in multiple transmission reception point communications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of downlink reference timing determination for physical random access channel in multiple transmission reception point communications as described herein. For example, the communications manager 920 may include a downlink reference timing component 930, an uplink timing manager 935, a random access manager 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The downlink reference timing component 930 may be configured as or otherwise support a means for determining two downlink reference timings for an uplink transmission within a serving cell, where two timing advance groups each associated with a respective timing advance offset are configured for the serving cell, and where each of the two downlink reference timings is associated with a respective timing advance group of the two timing advance groups. The uplink timing manager 935 may be configured as or otherwise support a means for determining an uplink timing for a random access preamble of a physical random access channel (PRACH) or a message A of a physical uplink shared channel (PUSCH) based on at least one of the two timing advance offsets, at least one of the two downlink reference timings, or any combination thereof. The random access manager 940 may be configured as or otherwise support a means for transmitting, as part of a random access procedure, the random access preamble in a valid PRACH occasion or the message A in a valid PUSCH occasion in accordance with the determined uplink timing.

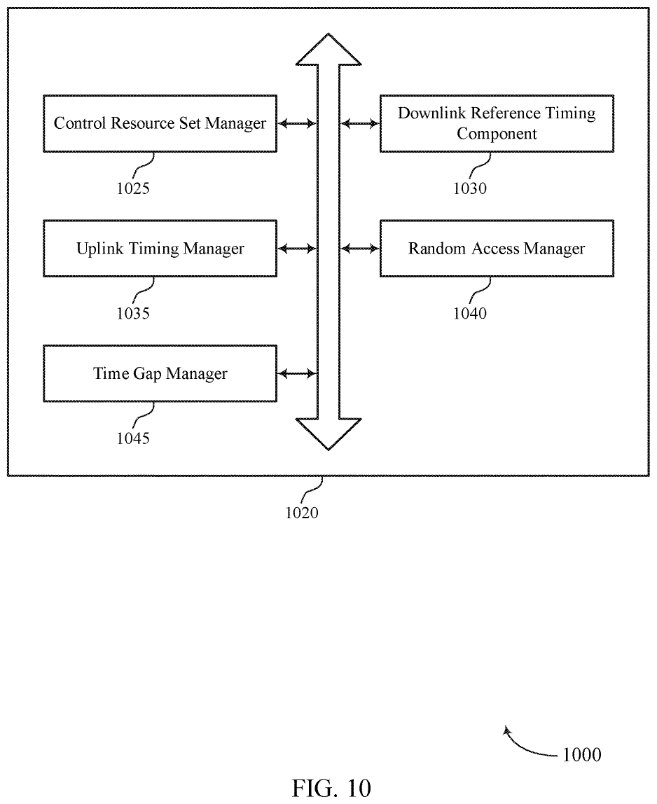

FIG. 10 shows a block diagram 1000 of a communications manager 1020 that supports downlink reference timing determination for physical random access channel in multiple transmission reception point communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of downlink reference timing determination for physical random access channel in multiple transmission reception point communications as described herein. For example, the communications manager 1020 may include a control resource set manager 1025, a downlink reference timing component 1030, an uplink timing manager 1035, a random access manager 1040, a time gap manager 1045, or any combination thereof. Each of these components may communicate, directly or indirectly, with one another (e.g., via one or more buses).

The communications manager 1020 may support wireless communication at a UE in accordance with examples as disclosed herein. The control resource set manager 1025 may be configured as or otherwise support a means for receiving control signaling indicating two control resource set pool index values in an active bandwidth part of at least one serving cell, where two timing advance groups each associated with a timing advance offset are configured for the serving cell. The downlink reference timing component 1030 may be configured as or otherwise support a means for determining two downlink reference timings for an uplink transmission within a serving cell, where two timing advance groups each associated with a respective timing advance offset are configured for the serving cell, and where each of the two downlink reference timings is associated with a respective timing advance group of the two timing advance groups. The uplink timing manager 1035 may be configured as or otherwise support a means for determining an uplink timing for a random access preamble of a physical random access channel (PRACH) or a message A of a physical uplink shared channel (PUSCH) based on at least one of the two timing advance offsets, at least one of the two downlink reference timings, or any combination thereof. The random access manager 1040 may be configured as or otherwise support a means for transmitting, as part of a random access procedure, the random access preamble in a valid PRACH occasion or the message A in a valid PUSCH occasion in accordance with the determined uplink timing.

In some examples, the uplink timing manager 1035 may be configured as or otherwise support a means for determining a single uplink timing for the random access preamble or the message A based on a single downlink reference timing of the two downlink reference timings and a single timing advance offset of the two timing advance offsets.

In some examples, the uplink timing manager 1035 may be configured as or otherwise support a means for identifying the single timing advance offset based on the single downlink reference timing. In some examples, the downlink reference timing component 1030 may be configured as or otherwise support a means for selecting the single downlink reference timing from among the two downlink reference timings based on the single downlink reference timing being an earliest in time among of the two downlink reference timings.

In some examples, the uplink timing manager 1035 may be configured as or otherwise support a means for identifying the single timing advance offset based on the single downlink reference timing. In some examples, the downlink reference timing component 1030 may be configured as or otherwise support a means for selecting the single downlink reference timing from among the two downlink reference timings based on the single downlink reference timing corresponding to a selected one of two control resource set pool index values for an active bandwidth part of the serving cell.

In some examples, the downlink reference timing component 1030 may be configured as or otherwise support a means for selecting the single downlink reference timing from among the two downlink reference timings and the single timing advance offset from among the two timing advance offsets based on an uplink timing associated with the single downlink reference timing and the single timing advance offset being earlier than another uplink timing associated with the other downlink reference timing of the two downlink reference timings and the other timing advance offset of the two timing advance offsets.

In some examples, the time gap manager 1045 may be configured as or otherwise support a means for determining a time gap in symbols between an uplink resource and the valid PRACH occasion or the valid PUSCH occasion based on the uplink resource being associated with a different downlink reference timing than the single downlink reference timing, a different timing advance offset than the single timing advance offset, or both.

In some examples, the time gap manager 1045 may be configured as or otherwise support a means for refraining, based on the uplink resource being associated with the different downlink reference timing or the different timing advance offset, from transmitting using the uplink resource in a same slot as a PRACH occasion or a PUSCH occasion, or when a gap between a symbol of the PRACH occasion or the PUSCH occasion and a symbol of the uplink resource is less than the determined time gap that is based at least in part on the PRACH occasion or the PUSCH occasion and the uplink resource both being associated with the same control resource set pool index value.

In some examples, the time gap manager 1045 may be configured as or otherwise support a means for refraining, based on identifying that simultaneous transmission using a PRACH occasion or a PUSCH occasion and the uplink resource allocated to the UE is unsupported, from transmitting using the uplink resource in a same slot as the PRACH occasion or the PUSCH occasion, or when a gap between a symbol of the PRACH occasion or the PUSCH occasion and a symbol of the uplink resource is less than the determined time gap that is based at least in part on the PRACH occasion or the PUSCH occasion and the uplink resource both being associated with a different control resource set pool index value.

In some examples, the time gap manager 1045 may be configured as or otherwise support a means for determining a time gap in symbols between a synchronization signal block occasion and the valid PRACH occasion or the valid PUSCH occasion based on the synchronization signal block occasion being associated with a first control resource set pool index value and the valid PRACH occasion or the valid PUSCH occasion being associated with a second control resource set pool index value different from the first control resource set.

In some examples, the random access manager 1040 may be configured as or otherwise support a means for determining that a first PRACH occasion is the valid PRACH occasion or a first PUSCH occasion is the valid PUSCH occasion based on the first PRACH occasion or the first PUSCH occasion being at or after a synchronization signal block occasion and at least a threshold quantity of symbols after a previously received synchronization signal block.

In some examples, the random access manager 1040 may be configured as or otherwise support a means for determining the threshold quantity of symbols based on whether the valid PRACH occasion or the valid PUSCH occasion and the synchronization signal block occasion are both associated with a same control resource set pool index value.

In some examples, the uplink timing manager 1035 may be configured as or otherwise support a means for determining a downlink reference timing of the two downlink reference timings based on a control resource set pool index value that is associated with the downlink reference timing being associated with a same control resource set pool index value associated with the valid PRACH occasion or the valid PUSCH occasion or a timing advance group of the two timing advance groups corresponding to the downlink reference timing and being associated with the same control resource set pool index value as the valid PRACH occasion or the valid PUSCH occasion, wherein the uplink timing is determined based at least in part on the determined downlink reference timing.

In some examples, the time gap manager 1045 may be configured as or otherwise support a means for refraining, based on a PRACH occasion or a PUSCH occasion and an uplink resource both being associated with a same control resource set pool index value, from transmitting using the uplink resource in a same slot as the PRACH occasion or the PUSCH occasion, or when a gap between a symbol of the PRACH occasion or the PUSCH occasion and a symbol of the uplink resource is less than a time gap.

In some examples, the time gap manager 1045 may be configured as or otherwise support a means for refraining, based on a PRACH occasion or a PUSCH occasion and an uplink resource both being associated with a different control resource set pool index value, from transmitting using the uplink resource in a same slot as the PRACH occasion or the PUSCH occasion, or when a gap between a symbol of the PRACH occasion or the PUSCH occasion and a symbol of the uplink resource is less than a time gap.

In some examples, the time gap manager 1045 may be configured as or otherwise support a means for determining a first value for a time gap between a synchronization signal block occasion and the valid PRACH occasion or the valid PUSCH occasion based on the synchronization signal block occasion being associated with a first control resource set pool index value and the valid PRACH occasion or the valid PUSCH occasion being associated with a second control resource set pool index different from the first control resource set pool index value, the first value for the time gap different from a second value for the time gap associated with synchronization signal block occasion and the valid PRACH occasion or PUSCH occasion being associated with a same control resource set pool index value.

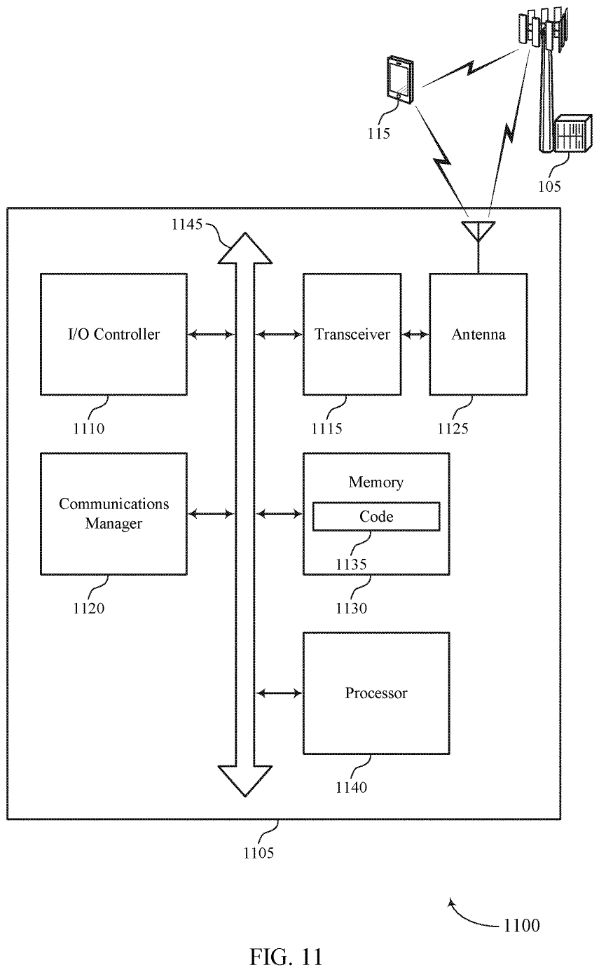

FIG. 11 shows a diagram of a system 1100 including a device 1105 that supports downlink reference timing determination for physical random access channel in multiple transmission reception point communications in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting downlink reference timing determination for physical random access channel in multiple transmission reception point communications). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for determining two downlink reference timings for an uplink transmission within a serving cell, where two timing advance groups each associated with a respective timing advance offset are configured for the serving cell, and where each of the two downlink reference timings is associated with a respective timing advance group of the two timing advance groups. The communications manager 1120 may be configured as or otherwise support a means for determining an uplink timing for a random access preamble of a physical random access channel (PRACH) or a message A of a physical uplink shared channel (PUSCH) based on at least one of the two timing advance offsets, at least one of the two downlink reference timings, or any combination thereof. The communications manager 1120 may be configured as or otherwise support a means for transmitting, as part of a random access procedure, the random access preamble in a valid PRACH occasion or the message A in a valid PUSCH occasion in accordance with the determined uplink timing.

By including or configuring the communications manager 1120 in accordance with examples as described herein, the device 1105 may support techniques for reduced processing by supporting the UE in determining timing advance values for random access preambles when the UE is operating according to a mDCI and MTRP mode.

In some examples, the communications manager 1120 may be configured to perform various operations (e.g., receiving, monitoring, transmitting) using or otherwise in cooperation with the transceiver 1115, the one or more antennas 1125, or any combination thereof. For example, the communications manager 1120 may be configured to receive or transmit messages or other signaling as described herein via the transceiver 1115. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of downlink reference timing determination for physical random access channel in multiple transmission reception point communications as described herein, or the processor 1140 and the memory 1130 may be otherwise configured to perform or support such operations.

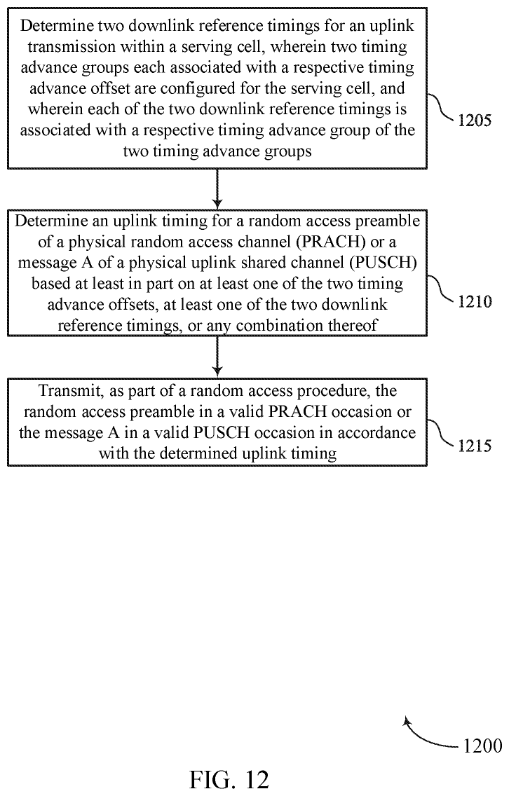

FIG. 12 shows a flowchart illustrating a method 1200 that supports downlink reference timing determination for physical random access channel in multiple transmission reception point communications in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include determining two downlink reference timings for an uplink transmission within a serving cell, wherein two timing advance groups each associated with a respective timing advance offset are configured for the serving cell, and wherein each of the two downlink reference timings is associated with a respective timing advance group of the two timing advance groups. The operations of 1205 may be performed in accordance with examples as disclosed herein. In some examples, aspects of the operations of 1205 may be performed by a downlink reference timing component 1030 as described with reference to FIG. 10. Additionally, or alternatively, means for performing 1205 may, but not necessarily, include, for example, antenna 1125, transceiver 1115, communications manager 1120, memory 1130 (including code 1135), processor 1140 and/or bus 1145.

At 1210, the method may include determining an uplink timing for a random access preamble of a physical random access channel (PRACH) or a message A of a physical uplink shared channel (PUSCH) based at least in part on at least one of the two timing advance offsets, at least one of the two downlink reference timings, or any combination thereof. The operations of 1210 may be performed in accordance with examples as disclosed herein. In some examples, aspects of the operations of 1210 may be performed by an uplink timing manager 1035 as described with reference to FIG. 10. Additionally, or alternatively, means for performing 1210 may, but not necessarily, include, for example, antenna 1125, transceiver 1115, communications manager 1120, memory qq30 (including code 1135), processor 1140 and/or bus 1145.

At 1215, the method may include transmitting, as part of a random access procedure, the random access preamble in a valid PRACH occasion or the message A in a valid PUSCH occasion in accordance with the determined uplink timing. The operations of 1215 may be performed in accordance with examples as disclosed herein. In some examples, aspects of the operations of 1215 may be performed by a random access manager 1040 as described with reference to FIG. 10. Additionally, or alternatively, means for performing 1215 may, but not necessarily, include, for example, antenna 1125, transceiver 1115, communications manager 1120, memory qq30 (including code 1135), processor 1140 and/or bus 1145.

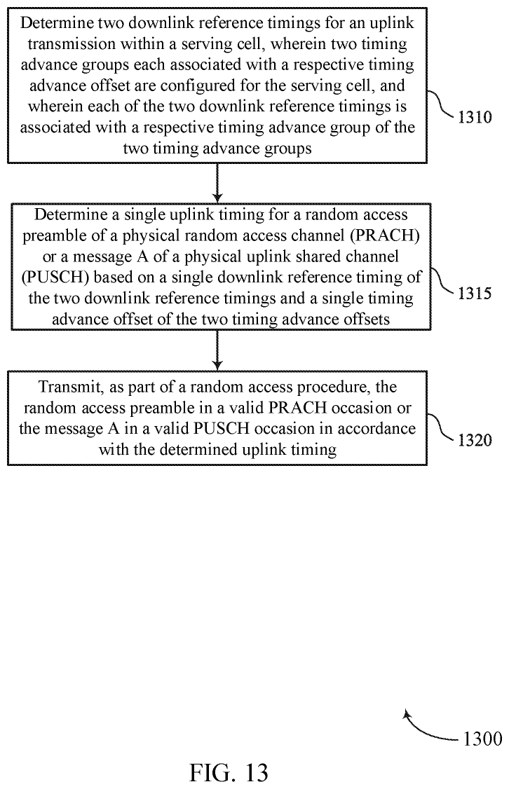

FIG. 13 shows a flowchart illustrating a method 1300 that supports downlink reference timing determination for physical random access channel in multiple transmission reception point communications in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1310, the method may include determining two downlink reference timings for an uplink transmission within a serving cell, wherein two timing advance groups each associated with a respective timing advance offset are configured for the serving cell, and wherein each of the two downlink reference timings is associated with a respective timing advance group of the two timing advance groups. The operations of 1310 may be performed in accordance with examples as disclosed herein. In some examples, aspects of the operations of 1310 may be performed by a downlink reference timing component 1030 as described with reference to FIG. 10. Additionally, or alternatively, means for performing 1310 may, but not necessarily, include, for example, antenna 1125, transceiver 1115, communications manager 1120, memory qq30 (including code 1135), processor 1140 and/or bus 1145.

At 1315, the method may include determining a single uplink timing for a random access preamble or the message A based on a single downlink reference timing of the two downlink reference timings and a single timing advance offset of the two timing advance offsets. The operations of 1315 may be performed in accordance with examples as disclosed herein. In some examples, aspects of the operations of 1315 may be performed by an uplink timing manager 1035 as described with reference to FIG. 10. Additionally, or alternatively, means for performing 1315 may, but not necessarily, include, for example, antenna 1125, transceiver 1115, communications manager 1120, memory qq30 (including code 1135), processor 1140 and/or bus 1145.

At 1320, the method may include transmitting a preamble in a valid PRACH occasion, or a message A in a valid PUSCH occasion, of a random access procedure in accordance with the determined single uplink timing. The operations of 1320 may be performed in accordance with examples as disclosed herein. In some examples, aspects of the operations of 1320 may be performed by a random access manager 1040 as described with reference to FIG. 10. Additionally, or alternatively, means for performing 1320 may, but not necessarily, include, for example, antenna 1125, transceiver 1115, communications manager 1120, memory qq30 (including code 1135), processor 1140 and/or bus 1145.

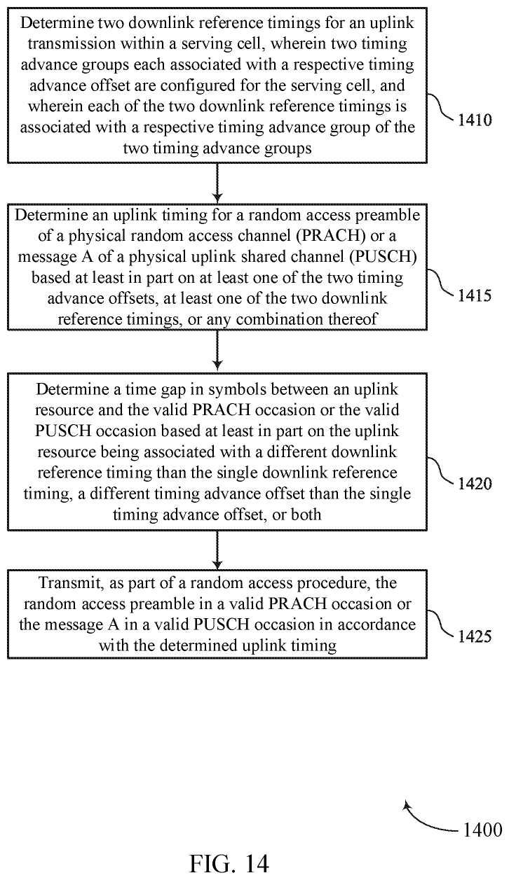

FIG. 14 shows a flowchart illustrating a method 1400 that supports downlink reference timing determination for physical random access channel in multiple transmission reception point communications in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1410, the method may include determining two downlink reference timings for an uplink transmission within a serving cell, wherein two timing advance groups each associated with a respective timing advance offset are configured for the serving cell, and wherein each of the two downlink reference timings is associated with a respective timing advance group of the two timing advance groups. The operations of 1410 may be performed in accordance with examples as disclosed herein. In some examples, aspects of the operations of 1410 may be performed by a downlink reference timing component 1030 as described with reference to FIG. 10. Additionally, or alternatively, means for performing 1410 may, but not necessarily, include, for example, antenna 1125, transceiver 1115, communications manager 1120, memory qq30 (including code 1135), processor 1140 and/or bus 1145.

At 1415, the method may include determining an uplink timing for a random access preamble of a physical random access channel (PRACH) or a message A of a physical uplink shared channel (PUSCH) based at least in part on at least one of the two timing advance offsets, at least one of the two downlink reference timings, or any combination thereof. The operations of 1415 may be performed in accordance with examples as disclosed herein. In some examples, aspects of the operations of 1415 may be performed by an uplink timing manager 1035 as described with reference to FIG. 10. Additionally, or alternatively, means for performing 1415 may, but not necessarily, include, for example, antenna 1125, transceiver 1115, communications manager 1120, memory qq30 (including code 1135), processor 1140 and/or bus 1145.

At 1420, the method may include determining a time gap in symbols between an uplink resource and the valid PRACH occasion or the valid PUSCH occasion based at least in part on the uplink resource being associated with a different downlink reference timing than the single downlink reference timing, a different timing advance offset than the single timing advance offset, or both. The operations of 1420 may be performed in accordance with examples as disclosed herein. In some examples, aspects of the operations of 1420 may be performed by a time gap manager 1045 as described with reference to FIG. 10. Additionally, or alternatively, means for performing 1420 may, but not necessarily, include, for example, antenna 1125, transceiver 1115, communications manager 1120, memory qq30 (including code 1135), processor 1140 and/or bus 1145.

At 1425, the method may include transmitting, as part of a random access procedure, the random access preamble in a valid PRACH occasion or the message A in a valid PUSCH occasion in accordance with the determined uplink timing. The operations of 1425 may be performed in accordance with examples as disclosed herein. In some examples, aspects of the operations of 1425 may be performed by random access manager 1035 as described with reference to FIG. 10. Additionally, or alternatively, means for performing 1425 may, but not necessarily, include, for example, antenna 1125, transceiver 1115, communications manager 1120, memory qq30 (including code 1135), processor 1140 and/or bus 1145.

The following provides an overview of aspects of the present disclosure:

Aspect 1: A method for wireless communication at a UE, comprising: determining two downlink reference timings for an uplink transmission within a serving cell, wherein two timing advance groups each associated with a respective timing advance offset are configured for the serving cell, and wherein each of the two downlink reference timings is associated with a respective timing advance group of the two timing advance groups; determining an uplink timing for a random access preamble of a physical random access channel (PRACH) or a message A of an PUSCH based at least in part on at least one of the two timing advance offsets, at least one of the two downlink reference timings, or any combination thereof; and transmitting, as part of a random access procedure, the random access preamble in a valid PRACH occasion or the message A in a valid PUSCH occasion in accordance with the determined uplink timing.

Aspect 2: The method of aspect 1, wherein determining the uplink timing further comprises: determining a single uplink timing for the random access preamble or the message A based on a single downlink reference timing of the two downlink reference timings and a single timing advance offset of the two timing advance offsets.

Aspect 3: The method of aspect 2, further comprising: identifying the single timing advance offset based at least in part on the single downlink reference timing; and selecting the single downlink reference timing from among the two downlink reference timings based at least in part on the single downlink reference timing being an earliest in time among of the two downlink reference timings.

Aspect 4: The method of any of aspects 2 through 4, further comprising: identifying the single timing advance offset based at least in part on the single downlink reference timing; and selecting the single downlink reference timing from among the two downlink reference timings based at least in part on the single downlink reference timing corresponding to a selected one of two control resource set pool index values for an active bandwidth part of the serving cell.

Aspect 5: The method of any of aspects 2 through 4, further comprising: selecting the single downlink reference timing from among the two downlink reference timings and the single timing advance offset from among the two timing advance offsets based at least in part on an uplink timing associated with the single downlink reference timing and the single timing advance offset being earlier than another uplink timing associated with the other downlink reference timing of the two downlink reference timings and the other timing advance offset of the two timing advance offsets.

Aspect 6: The method of any of aspects 2 through 5, further comprising: determining a time gap in symbols between an uplink resource and the valid PRACH occasion or the valid PUSCH occasion based at least in part on the uplink resource being associated with a different downlink reference timing than the single downlink reference timing, a different timing advance offset than the single timing advance offset, or both.

Aspect 7: The method of aspect 6, further comprising: refraining, based at least in part on the uplink resource being associated with the different downlink reference timing or the different timing advance offset, from transmitting using the uplink resource in a same slot as a PRACH occasion or a PUSCH occasion, or when a gap between a symbol of the PRACH occasion or the PUSCH occasion and a symbol of the uplink resource is less than the determined time gap.

Aspect 8: The method of any of aspects 6 through 7, further comprising: refraining, based at least in part on identifying that simultaneous transmission using a PRACH occasion or a PUSCH occasion and the uplink resource allocated to the UE is unsupported, from transmitting using the uplink resource in a same slot as the PRACH occasion or the PUSCH occasion, or when a gap between a symbol of the PRACH occasion or the PUSCH occasion and a symbol of the uplink resource is less than the determined time gap.

Aspect 9: The method of any of aspects 1 through 8, further comprising: determining a time gap in symbols between a synchronization signal block occasion and the valid PRACH occasion or the valid PUSCH occasion based at least in part on the synchronization signal block occasion being associated with a first control resource set pool index value and the valid PRACH occasion or the valid PUSCH occasion being associated with a second control resource set pool index value different from the first control resource set pool index value.

Aspect 10: The method of any of aspects 1 through 9, further comprising: determining that a first PRACH occasion is the valid PRACH occasion or a first PUSCH occasion is the valid PUSCH occasion based at least in part on the first PRACH occasion or the first PUSCH occasion being at or after a synchronization signal block occasion and at least a threshold quantity of symbols after a previously received synchronization signal block.

Aspect 11: The method of aspect 10, further comprising: determining the threshold quantity of symbols based at least in part on whether the valid PRACH occasion or the valid PUSCH occasion and the synchronization signal block occasion are both associated with a same control resource set pool index value.

Aspect 12: The method of any of aspects 1 through 11, wherein determining the uplink timing further comprises: determining a downlink reference timing of the two downlink reference timings based at least in part on a control resource set pool index value that is associated with the downlink reference timing being associated with a same control resource set pool index value associated with the valid PRACH occasion or the valid PUSCH occasion or a timing advance group of the two timing advance groups corresponding to the downlink reference timing and being associated with the same control resource set pool index value as the valid PRACH occasion or the valid PUSCH occasion, wherein the uplink timing is determined based at least in part on the determined downlink reference timing.

Aspect 13: The method of aspect 12, further comprising: refraining, based at least in part on a PRACH occasion or a PUSCH occasion and an uplink resource both being associated with a same control resource set pool index value, from transmitting using the uplink resource in a same slot as the PRACH occasion or the PUSCH occasion, or when a gap between a symbol of the PRACH occasion or the PUSCH occasion and a symbol of the uplink resource is less than a time gap that is based at least in part on the PRACH occasion or the PUSCH occasion and the uplink resource both being associated with the same control resource set pool index value.

Aspect 14: The method of aspect 12, further comprising: refraining, based at least in part on a PRACH occasion or a PUSCH occasion and an uplink resource both being associated with a different control resource set pool index value, from transmitting using the uplink resource in a same slot as the PRACH occasion or the PUSCH occasion, or when a gap between a symbol of the PRACH occasion or the PUSCH occasion and a symbol of the uplink resource is less than a time gap that is based at least in part on the PRACH occasion or the PUSCH occasion and the uplink resource both being associated with a different control resource set pool index value.

Aspect 15: The method of any of aspects 12 through 14, wherein further comprising: determining a first value for a time gap between a synchronization signal block occasion and the valid PRACH occasion or the valid PUSCH occasion based at least in part on the synchronization signal block occasion being associated with a first control resource set pool index value and the valid PRACH occasion or the valid PUSCH occasion being associated with a second control resource set pool index value different from the first control resource set pool index value, the first value for the time gap different from a second value for the time gap associated with synchronization signal block occasion and the valid PRACH occasion or PUSCH occasion being associated with a same control resource set pool index value.

Aspect 16: An apparatus for wireless communication at a UE, comprising memory, a transceiver, and at least one processor of the UE, the at least one processor coupled with the memory and the transceiver and configured to perform a method of any of aspects 1 through 15.

Aspect 17: An apparatus for wireless communication at a UE, comprising at least one means for performing a method of any of aspects 1 through 15.

Aspect 18: A non-transitory computer-readable medium storing code for wireless communication at a UE, the code comprising instructions executable by a processor to perform a method of any of aspects 1 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a user equipment (UE), comprising:
determining two downlink reference timings for an uplink transmission within at least one serving cell, wherein two timing advance groups each associated with a respective timing advance offset are configured for the at least one serving cell, and wherein each of the two downlink reference timings is associated with a respective timing advance group of the two timing advance groups;
determining an uplink timing for a random access preamble of a physical random access channel (PRACH) or a message A of a physical uplink shared channel (PUSCH) based at least in part on at least one of the two timing advance offsets, at least one of the two downlink reference timings, or any combination thereof; and
transmitting, as part of a random access procedure, the random access preamble in a valid PRACH occasion or the message A in a valid PUSCH occasion in accordance with the determined uplink timing.

2. The method of claim 1, wherein determining the uplink timing further comprises:
determining a single uplink timing for the random access preamble or the message A based on a single downlink reference timing of the two downlink reference timings and a single timing advance offset of the two timing advance offsets.

3. The method of claim 2, further comprising:
identifying the single timing advance offset based at least in part on the single downlink reference timing; and
selecting the single downlink reference timing from among the two downlink reference timings, the selecting based at least in part on the single downlink reference timing being an earliest in time among of the two downlink reference timings or based at least in part on the single downlink reference timing corresponding to a selected one of two control resource set pool index values for an active bandwidth part of the at least one serving cell.

4. (canceled)

5. The method of claim 2, further comprising:
selecting the single downlink reference timing from among the two downlink reference timings and the single timing advance offset from among the two timing advance offsets based at least in part on an uplink timing associated with the single downlink reference timing and the single timing advance offset being earlier than another uplink timing associated with the other downlink reference timing of the two downlink reference timings and the other timing advance offset of the two timing advance offsets.

6. (canceled)

7. The method of claim 2, further comprising:
determining a time gap in symbols between an uplink resource and the valid PRACH occasion or the valid PUSCH occasion based at least in part on the uplink resource being associated with a different downlink reference timing than the single downlink reference timing, a different timing advance offset than the single timing advance offset, or both; and
refraining from transmitting using the uplink resource in a same slot as a PRACH occasion or a PUSCH occasion, or when a gap between a symbol of the PRACH occasion or the PUSCH occasion and a symbol of the uplink resource is less than the determined time gap, the refraining based at least in part on:
the uplink resource being associated with the different downlink reference timing or the different timing advance offset, or
identifying that simultaneous transmission using the PRACH occasion or the PUSCH occasion and the uplink resource allocated to the UE is unsupported.

8. (canceled)

9. The method of claim 1, further comprising:
determining a time gap in symbols between a synchronization signal block occasion and the valid PRACH occasion or the valid PUSCH occasion based at least in part on the synchronization signal block occasion being associated with a first control resource set pool index value and the valid PRACH occasion or the valid PUSCH occasion being associated with a second control resource set pool index value different from the first control resource set pool index value.

10. The method of claim 1, further comprising:
determining that a first PRACH occasion is the valid PRACH occasion or a first PUSCH occasion is the valid PUSCH occasion based at least in part on the first PRACH occasion or the first PUSCH occasion being at or after a synchronization signal block occasion and at least a threshold quantity of symbols after a previously received synchronization signal block; and
determining the threshold quantity of symbols based at least in part on whether the valid PRACH occasion or the valid PUSCH occasion and the synchronization signal block occasion are both associated with a same control resource set pool index value.

11. (canceled)

12. The method of claim 1, wherein determining the uplink timing further comprises:
determining a downlink reference timing of the two downlink reference timings based at least in part on a control resource set pool index value that is associated with the downlink reference timing being associated with a same control resource set pool index value associated with the valid PRACH occasion or the valid PUSCH occasion or a timing advance group of the two timing advance groups corresponding to the downlink reference timing and being associated with the same control resource set pool index value as the valid PRACH occasion or the valid PUSCH occasion, wherein the uplink timing is determined based at least in part on the determined downlink reference timing.

13. The method of claim 12, further comprising:
refraining from transmitting using an uplink resource in a same slot as a PRACH occasion or a PUSCH occasion, or when a gap between a symbol of the PRACH occasion or the PUSCH occasion and a symbol of the uplink resource is less than a time gap, the time gap being based at least in part on the PRACH occasion or the PUSCH occasion and the uplink resource both being associated with the same control resource set pool index value or based at least in part on the PRACH occasion or the PUSCH occasion and the uplink resource both being associated with a different control resource set pool index value.

14. (canceled)

15. The method of claim 12, wherein further comprising:
determining a first value for a time gap between a synchronization signal block occasion and the valid PRACH occasion or the valid PUSCH occasion based at least in part on the synchronization signal block occasion being associated with a first control resource set pool index value and the valid PRACH occasion or the valid PUSCH occasion being associated with a second control resource set pool index value different from the first control resource set pool index value, the first value for the time gap different from a second value for the time gap associated with synchronization signal block occasion and the valid PRACH occasion or PUSCH occasion being associated with a same control resource set pool index value.

16. An apparatus for wireless communication at a user equipment (UE), comprising:
memory;
a transceiver; and
at least one processor of a user equipment (UE), the at least one processor coupled with the memory and the transceiver and configured to:
determine two downlink reference timings for an uplink transmission within at least one serving cell, wherein two timing advance groups each associated with a respective timing advance offset are configured for the at least one serving cell, and wherein each of the two downlink reference timings is associated with a respective timing advance group of the two timing advance groups;
determine an uplink timing for a random access preamble of a physical random access channel (PRACH) or a message A of a physical uplink shared channel (PUSCH) based at least in part on at least one of the two timing advance offsets, at least one of the two downlink reference timings, or any combination thereof; and
transmit, via the transceiver, as part of a random access procedure, the random access preamble in a valid PRACH occasion or the message A in a valid PUSCH occasion in accordance with the determined uplink timing.

17. The apparatus of claim 16, wherein, to determine the uplink timing, the at least one processor is further configured to:
determine a single uplink timing for the random access preamble or the message A based on a single downlink reference timing of the two downlink reference timings and a single timing advance offset of the two timing advance offsets.

18. The apparatus of claim 17, the at least one processor further configured to:
identify the single timing advance offset based at least in part on the single downlink reference timing; and
select the single downlink reference timing from among the two downlink reference timings, the selecting based at least in part on the single downlink reference timing being an earliest in time among of the two downlink reference timings or based at least in part on the single downlink reference timing corresponding to a selected one of two control resource set pool index values for an active bandwidth part of the at least one serving cell.

19. (canceled)

20. The apparatus of claim 17, the at least one processor further configured to:
select the single downlink reference timing from among the two downlink reference timings and the single timing advance offset from among the two timing advance offsets based at least in part on an uplink timing associated with the single downlink reference timing and the single timing advance offset being earlier than another uplink timing associated with the other downlink reference timing of the two downlink reference timings and the other timing advance offset of the two timing advance offsets.

21. (canceled)

22. The apparatus of claim 17, the at least one processor further configured to:
determine a time gap in symbols between an uplink resource and the valid PRACH occasion or the valid PUSCH occasion based at least in part on the uplink resource being associated with a different downlink reference timing than the single downlink reference timing, a different timing advance offset than the single timing advance offset, or both; and
refrain from transmitting using the uplink resource in a same slot as a PRACH occasion or a PUSCH occasion, or when a gap between a symbol of the PRACH occasion or the PUSCH occasion and a symbol of the uplink resource is less than the determined time gap, the refraining based at least in part on:
the uplink resource being associated with the different downlink reference timing or the different timing advance offset, or
identifying that simultaneous transmission using the PRACH occasion or the PUSCH occasion and the uplink resource allocated to the UE is unsupported.

23. (canceled)

24. The apparatus of claim 16, the at least one processor further configured to:
determine a time gap in symbols between a synchronization signal block occasion and the valid PRACH occasion or the valid PUSCH occasion based at least in part on the synchronization signal block occasion being associated with a first control resource set pool index value and the valid PRACH occasion or the valid PUSCH occasion being associated with a second control resource set pool index value different from the first control resource set pool index value.

25. The apparatus of claim 16, the at least one processor further configured to:
determine that a first PRACH occasion is the valid PRACH occasion or a first PUSCH occasion is the valid PUSCH occasion based at least in part on the first PRACH occasion or the first PUSCH occasion being at or after a synchronization signal block occasion and at least a threshold quantity of symbols after a previously received synchronization signal block; and
determine the threshold quantity of symbols based at least in part on whether the valid PRACH occasion or the valid PUSCH occasion and the synchronization signal block occasion are both associated with a same control resource set pool index.

26. (canceled)

27. The apparatus of claim 16, wherein, to determine the uplink timing, the at least one processor is further configured to:
determine a downlink reference timing of the two downlink reference timings based at least in part on a control resource set pool index value that is associated with the downlink reference timing being associated with a same control resource set pool index value associated with the valid PRACH occasion or the valid PUSCH occasion or a timing advance group of the two timing advance groups corresponding to the downlink reference timing and being associated with the same control resource set pool index value as the valid PRACH occasion or the valid PUSCH occasion, wherein the uplink timing is determined based at least in part on the determined downlink reference timing.

28. The apparatus of claim 27, the at least one processor further configured to:
refrain from transmitting using an uplink resource in a same slot as a PRACH occasion or a PUSCH occasion, or when a gap between a symbol of the PRACH occasion or the PUSCH occasion and a symbol of the uplink resource is less than a time gap, the time gap being based at least in part on the PRACH occasion or the PUSCH occasion and the uplink resource both being associated with the same control resource set pool index value or based at least in part on the PRACH occasion or the PUSCH occasion and the uplink resource both being associated with a different control resource set pool index value.

29. (canceled)

30. A non-transitory computer-readable medium storing code for wireless communication at a user equipment (UE), the code comprising instructions executable by a processor to:
determine two downlink reference timings for an uplink transmission within at least one serving cell, wherein two timing advance groups each associated with a respective timing advance offset are configured for the at least one serving cell, and wherein each of the two downlink reference timings is associated with a respective timing advance group of the two timing advance groups;
determine an uplink timing for a random access preamble of a physical random access channel (PRACH) or a message A of a physical uplink shared channel (PUSCH) based at least in part on at least one of the two timing advance offsets, at least one of the two downlink reference timings, or any combination thereof; and
transmit, as part of a random access procedure, the random access preamble in a valid PRACH occasion or the message A in a valid PUSCH occasion in accordance with the determined uplink timing.
